(19) United States
(12) Patent Application Publication
(10) Pub. No.: US 2015/0130814 A1
(43) Pub. Date: May 14, 2015

(54) DATA COLLECTION FOR MULTIPLE VIEW GENERATION

(71) Applicant: Amazon Technologies, Inc., Reno, NV (US)

(72) Inventors: Quais Taraki, Bellevue, WA (US); Vinod Murli Mamtani, Bellevue, WA (US); Matthew Vahlsing, Seattle, WA (US); James Jonathan Morris, Duvall, WA (US); Gerard Joseph Heinz, II, Seattle, WA (US); Nicholas Patrick Wilt, Mercer Island, WA (US)

(21) Appl. No.: 14/077,149

(22) Filed: Nov. 11, 2013

(51) Int. Cl. G06T 11/40; H04L 29/06

(52) U.S. Cl. CPC G06T 11/40; H04L 65/607
USPC 345/441

(57) ABSTRACT

In some cases, one or more rendered views of a scene of a particular content item, such as a video game, may be generated by a content provider and transmitted from the content provider to multiple different clients. Additionally, in some cases, a content provider may employ multiple graphics processing units to generate the one or more views. Furthermore, in some cases, data associated with multiple different views of a scene may be combined into a single data collection, such as a render target.

### CROSS REFERENCE TO RELATED APPLICATIONS

This application is related to the following applications, each of which is hereby incorporated by reference in its entirety: U.S. patent application Ser. No. ______ filed Nov. 11, 2013, entitled “VIDEO ENCODING BASED ON AREAS OF INTEREST” (Attorney Docket Number: AMAZ-0083); U.S. patent application Ser. No. ______ filed Nov. 11, 2013, entitled “ADAPTIVE SCENE COMPLEXITY BASED ON SERVICE QUALITY” (Attorney Docket Number: AMAZ-0084); U.S. patent application Ser. No. ______ filed Nov. 11, 2013, entitled “SERVICE FOR GENERATING GRAPHICS OBJECT DATA” (Attorney Docket Number: AMAZ-0086); U.S. patent application Ser. No. ______ filed Nov. 11, 2013, entitled “IMAGE COMPOSITION BASED ON REMOTE OBJECT DATA” (Attorney Docket Number: AMAZ-0087); U.S. patent application Ser. No. ______ filed Nov. 11, 2013, entitled “MULTIPLE PARALLEL GRAPHICS PROCESSING UNITS” (Attorney Docket Number: AMAZ-0110); U.S. patent application Ser. No. ______ filed Nov. 11, 2013, entitled “ADAPTIVE CONTENT TRANSMISSION” (Attorney Docket Number: AMAZ-0114); U.S. patent application Ser. No. ______ filed Nov. 11, 2013, entitled “VIEW GENERATION BASED ON SHARED STATE” (Attorney Docket Number: AMAZ-0115); U.S. patent application Ser. No. ______ filed Nov. 11, 2013, entitled “MULTIPLE STREAM CONTENT PRESENTATION” (Attorney Docket Number: AMAZ-0116); U.S. patent application Ser. No. ______ filed Nov. 11, 2013, entitled “STREAMING GAME SERVER VIDEO RECORDER” (Attorney Docket Number: AMAZ-0125); U.S. patent application Ser. No. ______ filed Nov. 11, 2013, entitled “LOCATION OF ACTOR RESOURCES” (Attorney Docket Number: AMAZ-0128); U.S. patent application Ser. No. ______ filed Nov. 11, 2013, entitled “SESSION IDLE OPTIMIZATION FOR STREAMING SERVER” (Attorney Docket Number: AMAZ-0129); U.S. patent application Ser. No. ______ filed Nov. 11, 2013, entitled “APPLICATION STREAMING SERVICE” (Attorney Docket Number: AMAZ-0139); U.S. patent application Ser. No. ______ filed Nov. 11, 2013, entitled “EFFICIENT BANDWIDTH ESTIMATION” (Attorney Docket Number: AMAZ-0141).

### BACKGROUND

Some recent technological advances have made it possible for multiple clients at multiple different remote locations to interact with each other as part of a common multimedia content experience. For example, some conventional video games may be played collectively using different clients at different remote locations. In some cases, each client may have associated state information corresponding to actions, events or other information associated with the client's participation in the game. For example, state information may include information associated with actions performed by a particular character or other entity controlled by the respective client. One conventional approach to enable multiple client interaction involves periodically transmitting game state information from each participating client to a server, which in turn may forward back, to each client, updated state information received from each of the other clients. Each of the clients may use this updated state information to maintain its own respective individual game state, which in turn may be used to render, at each client, a respective presentation of the video game. For example, each particular client may present scenes within the video game from a perspective of a particular character or other entity controlled by the respective client.

While the above described conventional techniques may enable multiple client interaction, they may also involve a number of drawbacks. For example, the need to maintain state and render images at the client devices may raise the complexity and usage requirements of content presentation software on the client devices. This may result in consumption of large amounts of resources on client devices that often provide limited capabilities. For example, client devices are often targeted to consumers that prefer devices with smaller size, greater portability and lower cost. Additionally, temporary delays or disruptions in the presentation of content may occur when updated state information cannot be effectively transmitted from the server to the multiple clients. Furthermore, the presence of more sophisticated gaming or other content on client devices may present piracy and other security concerns for creators and distributors of the content. Moreover, as content items continue to become more detailed and complex, it is increasingly likely client devices, which typically include only a single graphics processing unit, may not be capable of effectively rendering such content.

### BRIEF DESCRIPTION OF DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a diagram illustrating an example computing system that may be used in some embodiments.

FIG. 2 is a diagram illustrating an example computing system that may be used in some embodiments.

FIG. 3A is a diagram illustrating an example system for multiple view generation in accordance with the present disclosure.

FIG. 3B is a diagram illustrating an example system for identical view generation in accordance with the present disclosure.

FIG. 4 is a diagram illustrating a first example content transmission system in accordance with the present disclosure.

FIG. 5 is a diagram illustrating a second example content transmission system in accordance with the present disclosure.

FIG. 6 is a diagram illustrating a third example content transmission system in accordance with the present disclosure.

FIG. 7 is a diagram illustrating a first example graphics processing unit scaling scenario in accordance with the present disclosure.

FIG. 8 is a diagram illustrating a second example graphics processing unit scaling scenario in accordance with the present disclosure.

FIG. 9 is a diagram illustrating a third example graphics processing unit scaling scenario in accordance with the present disclosure.

FIG. 10 is a diagram illustrating a fourth example graphics processing unit scaling scenario in accordance with the present disclosure.

FIG. 11 is a diagram illustrating an example stitching technique in accordance with the present disclosure.

FIG. 12 is a diagram illustrating example layers in accordance with the present disclosure.

FIG. 13 is a diagram illustrating an example layering technique in accordance with the present disclosure.

FIG. 14 is a diagram illustrating an example content provider system in accordance with the present disclosure.

FIG. 15 is a flowchart depicting an example procedure for generating one or more views based on shared state information in accordance with the present disclosure.

FIG. 16 is a flowchart depicting an example procedure for rendering using one or more graphics processing units in accordance with the present disclosure.

FIG. 17 is a diagram illustrating an example system employing a data collection for multiple view generation in accordance with the present disclosure.

FIG. 18 is a diagram illustrating a first example data collection including data associated with multiple views in accordance with the present disclosure.

FIG. 19 is a diagram illustrating an example representation formation sequence in accordance with the present disclosure.

FIG. 20 is a diagram illustrating a second example data collection including data associated with multiple views in accordance with the present disclosure.

FIG. 21 is a flowchart depicting an example procedure for employing a data collection for multiple view generation in accordance with the present disclosure.

### DETAILED DESCRIPTION

In accordance with some example features of the disclosed techniques, one or more rendered views of a scene of a particular content item, such as a video game, may be generated by a content provider and transmitted from the content provider to multiple different clients. In some cases, a content provider may generate multiple views of a scene of a particular content item. Each of the multiple views may, for example, be associated with one or more respective clients and may be transmitted from the content provider to the respective clients. For example, each view may present a scene from a viewpoint of a particular character or other entity controlled by a respective client to which the view is transmitted. In some cases, the content provider may transmit an identical view of a scene of a particular content item to multiple clients. Identical views may, for example, be transmitted to clients that control closely related characters or that collaborate to control a single character.

To enable generation of the one or more views of a scene, each of the different participating clients may collect respective client state information. The client state information may include, for example, information regarding operations performed at the respective client, such as movements or other actions performed by a respective character or other entity controlled by the respective client. Each of the respective clients may periodically transmit an update of its respective client state information to the content provider. The content provider may then use the client state information updates received from each client to update shared content item state information maintained by the content provider. The content provider may then use the shared content item state information to generate the one or more views transmitted to the different participating clients. In some cases, one or more of the participating clients may operate in a hybrid mode in which, in addition to receiving one or more views from the content provider, the hybrid mode clients execute their own local version of the content item and generate their own local client streams. Each hybrid mode client may then combine, locally at the client, a received content provider stream of views with the local client stream to generate and display a hybrid content item stream.

In some cases, a content provider may employ multiple graphics processing units to generate the one or more views of a scene of a particular content item. In some cases, the multiple graphics processing units may generate renderings associated with a particular scene at least partially simultaneously with one another. Also, in some cases, the use of multiple graphics processing units may assist in enabling real time or near-real time generation and presentation of rendered views. In some cases, multiple graphics processing units may each render a respective portion of a scene that is used to generate one or more resulting views for display. In some cases, for each view, the renderings may be combined to form the view by, for example, stitching the renderings together or employing a representation in which the renderings are logically combined at different associated layers. In some cases, the number of graphics processing units that are used to render a particular content item may be elastic such that the number changes depending on various factors. Such factors may include, for example, a performance rate associated with one or more graphics processing units, a complexity of rendered scenes, a number of views associated with the rendered scenes, availability of additional graphics processing units and any other relevant factors.

In some cases, multiple different views of a scene may be combined into a single data collection, such as a render target. For example, such a single data collection may include multiple sections, each associated with a respective one of the multiple views. Each section of the data collection may then be separately retrieved, encoded and transmitted over a network. In some cases, each object within the scene may have an associated representation that is formed in each section of the data collection prior to moving on to a next object. For example, representations of a first object may be formed across each section of the data collection prior to forming representations of a second object. This formation sequence may, in some cases, reduce state changes associated with loading of data associated with each object including, for example, various geometry, textures, shaders and the like.

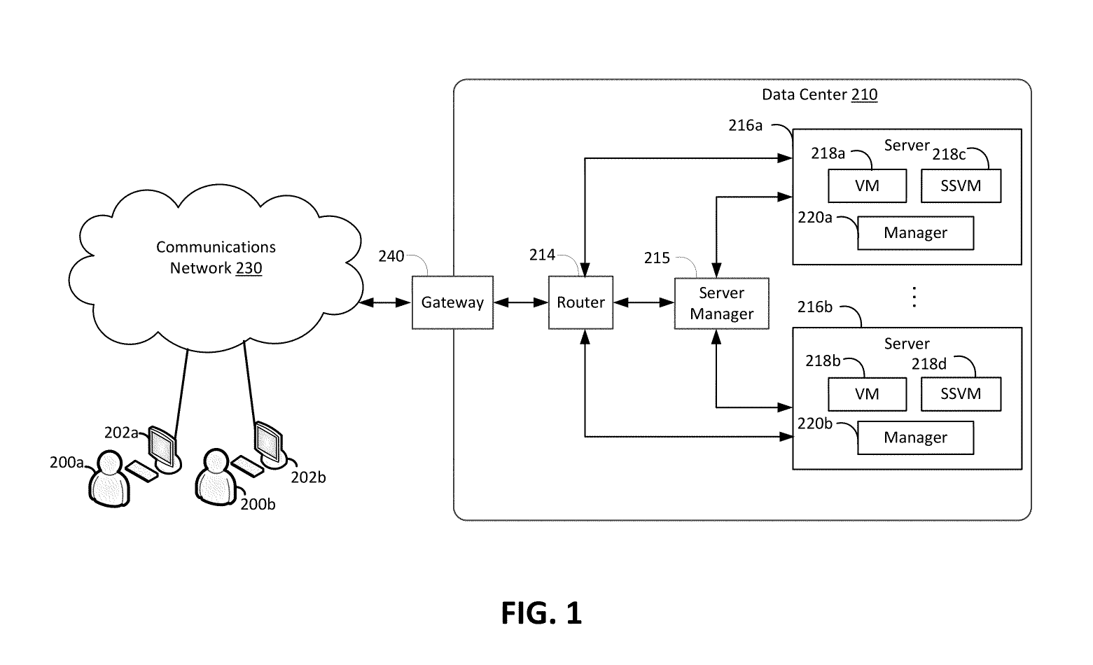

A content provider may, in some cases, render and transmit content item views to clients over an electronic network, such as the Internet. Content may, in some cases, be provided upon request to clients using, for example, streaming content delivery techniques. An example computing environment that enables rendering and transmission of content to clients will now be described in detail. In particular, FIG. 1 illustrates an example computing environment in which the embodiments described herein may be implemented. FIG. 1 is a diagram schematically illustrating an example of a data center 210 that can provide computing resources to users 200a and 200b (which may be referred herein singularly as user 200 or in the plural as users 200) via user computers 202a and 202b (which may be referred herein singularly as computer 202 or in the plural as computers 202) via a communications network 230. Data center 210 may be configured to provide computing resources for executing applications on a permanent or an as-needed basis. The computing resources provided by data center 210 may include various types of resources, such as gateway resources, load balancing resources, routing resources, networking resources, computing resources, volatile and non-volatile memory resources, content delivery resources, data processing resources, data storage resources, data communication resources and the like. Each type of computing resource may be general-purpose or may be available in a number of specific configurations. For example, data processing resources may be available as virtual machine instances that may be configured to provide various web services. In addition, combinations of resources may be made available via a network and may be configured as one or more web services. The instances may be configured to execute applications, including web services, such as application services, media services, database services, processing services, gateway services, storage services, routing services, security services, encryption services, load balancing services, application services and the like. These services may be configurable with set or custom applications and may be configurable in size, execution, cost, latency, type, duration, accessibility and in any other dimension. These web services may be configured as available infrastructure for one or more clients and can include one or more applications configured as a platform or as software for one or more clients. These web services may be made available via one or more communications protocols. These communications protocols may include, for example, hypertext transfer protocol (HTTP) or non-HTTP protocols. These communications protocols may also include, for example, more reliable transport layer protocols, such as transmission control protocol (TCP), and less reliable transport layer protocols, such as user datagram protocol (UDP). Data storage resources may include file storage devices, block storage devices and the like.

Each type or configuration of computing resource may be available in different sizes, such as large resources—consisting of many processors, large amounts of memory and/or large storage capacity—and small resources—consisting of fewer processors, smaller amounts of memory and/or smaller storage capacity. Customers may choose to allocate a number of small processing resources as web servers and/or one large processing resource as a database server, for example.

Data center 210 may include servers 216a and 216b (which may be referred herein singularly as server 216 or in the plural as servers 216) that provide computing resources. These resources may be available as bare metal resources or as virtual machine instances 218a-d (which may be referred herein singularly as virtual machine instance 218 or in the plural as virtual machine instances 218). Virtual machine instances 218c and 218d are shared state virtual machine (“SSVM”) instances. The SSVM virtual machine instances 218c and 218d may be configured to perform all or any portion of the shared content item state techniques and/or any other of the disclosed techniques in accordance with the present disclosure and described in detail below. As should be appreciated, while the particular example illustrated in FIG. 1 includes one SSVM virtual machine in each server, this is merely an example. A server may include more than one SSVM virtual machine or may not include any SSVM virtual machines.

The availability of virtualization technologies for computing hardware has afforded benefits for providing large scale computing resources for customers and allowing computing resources to be efficiently and securely shared between multiple customers. For example, virtualization technologies may allow a physical computing device to be shared among multiple users by providing each user with one or more virtual machine instances hosted by the physical computing device. A virtual machine instance may be a software emulation of a particular physical computing system that acts as a distinct logical computing system. Such a virtual machine instance provides isolation among multiple operating systems sharing a given physical computing resource. Furthermore, some virtualization technologies may provide virtual resources that span one or more physical resources, such as a single virtual machine instance with multiple virtual processors that span multiple distinct physical computing systems.

Referring to FIG. 1, communications network 230 may, for example, be a publicly accessible network of linked networks and possibly operated by various distinct parties, such as the Internet. In other embodiments, communications network 230 may be a private network, such as a corporate or university network that is wholly or partially inaccessible to non-privileged users. In still other embodiments, communications network 230 may include one or more private networks with access to and/or from the Internet.

Communication network 230 may provide access to computers 202. User computers 202 may be computers utilized by users 200 or other customers of data center 210. For instance, user computer 202a or 202b may be a server, a desktop or laptop personal computer, a tablet computer, a wireless telephone, a personal digital assistant (PDA), an e-book reader, a game console, a set-top box or any other computing device capable of accessing data center 210. User computer 202a or 202b may connect directly to the Internet (e.g., via a cable modem or a Digital Subscriber Line (DSL)). Although only two user computers 202a and 202b are depicted, it should be appreciated that there may be multiple user computers.

User computers 202 may also be utilized to configure aspects of the computing resources provided by data center 210. In this regard, data center 210 might provide a gateway or web interface through which aspects of its operation may be configured through the use of a web browser application program executing on user computer 202. Alternately, a stand-alone application program executing on user computer 202 might access an application programming interface (API) exposed by data center 210 for performing the configuration operations. Other mechanisms for configuring the operation of various web services available at data center 210 might also be utilized.

Servers 216 shown in FIG. 1 may be standard servers configured appropriately for providing the computing resources described above and may provide computing resources for executing one or more web services and/or applications. In one embodiment, the computing resources may be virtual machine instances 218. In the example of virtual machine instances, each of the servers 216 may be configured to execute an instance manager 220a or 220b (which may be referred herein singularly as instance manager 220 or in the plural as instance managers 220) capable of executing the virtual machine instances 218. The instance managers 220 may be a virtual machine monitor (VMM) or another type of program configured to enable the execution of virtual machine instances 218 on server 216, for example. As discussed above, each of the virtual machine instances 218 may be configured to execute all or a portion of an application.

It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 210 shown in FIG. 1, a router 214 may be utilized to interconnect the servers 216a and 216b. Router 214 may also be connected to gateway 240, which is connected to communications network 230. Router 214 may be connected to one or more load balancers, and alone or in combination may manage communications within networks in data center 210, for example, by forwarding packets or other data communications as appropriate based on characteristics of such communications (e.g., header information including source and/or destination addresses, protocol identifiers, size, processing requirements, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

In the example data center 210 shown in FIG. 1, a server manager 215 is also employed to at least in part direct various communications to, from and/or between servers 216a and 216b. While FIG. 1 depicts router 214 positioned between gateway 240 and server manager 215, this is merely an exemplary configuration. In some cases, for example, server manager 215 may be positioned between gateway 240 and router 214. Server manager 215 may, in some cases, examine portions of incoming communications from user computers 202 to determine one or more appropriate servers 216 to receive and/or process the incoming communications. Server manager 215 may determine appropriate servers to receive and/or process the incoming communications based on factors such as an identity, location or other attributes associated with user computers 202, a nature of a task with which the communications are associated, a priority of a task with which the communications are associated, a duration of a task with which the communications are associated, a size and/or estimated resource usage of a task with which the communications are associated and many other factors. Server manager 215 may, for example, collect or otherwise have access to state information and other information associated with various tasks in order to, for example, assist in managing communications and other operations associated with such tasks.

It should be appreciated that the network topology illustrated in FIG. 1 has been greatly simplified and that many more networks and networking devices may be utilized to interconnect the various computing systems disclosed herein. These network topologies and devices should be apparent to those skilled in the art.

It should also be appreciated that data center 210 described in FIG. 1 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders) and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

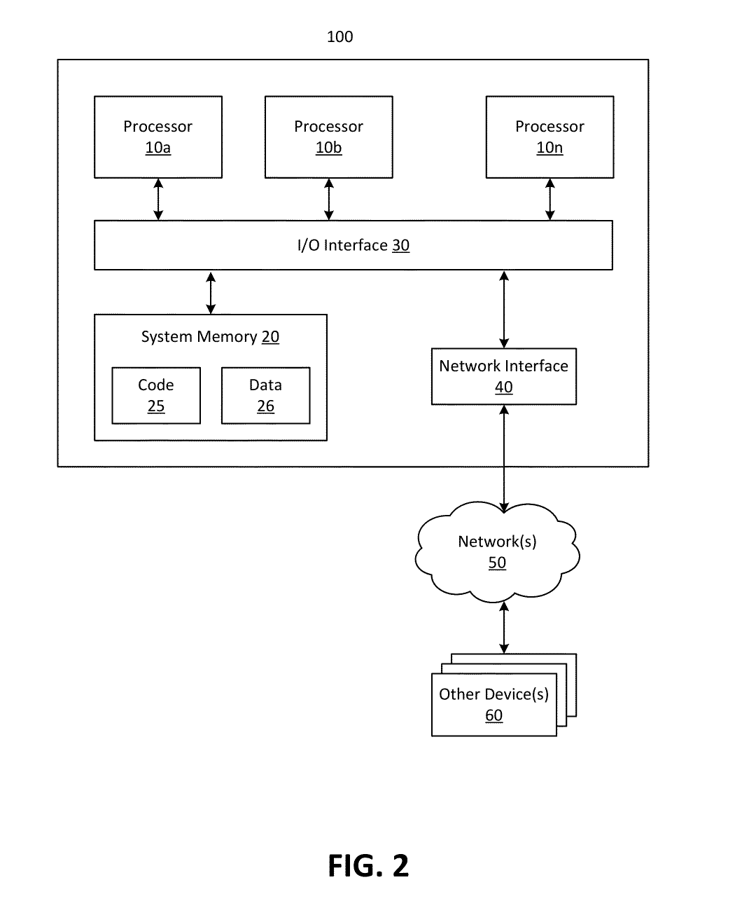

In at least some embodiments, a server that implements a portion or all of one or more of the technologies described herein may include a general-purpose computer system that includes or is configured to access one or more computer-accessible media. FIG. 2 depicts a general-purpose computer system that includes or is configured to access one or more computer-accessible media. In the illustrated embodiment, computing device 100 includes one or more processors 10a, 10b and/or 10n (which may be referred herein singularly as “a processor 10” or in the plural as “the processors 10”) coupled to a system memory 20 via an input/output (I/O) interface 30. Computing device 100 further includes a network interface 40 coupled to I/O interface 30.

In various embodiments, computing device 100 may be a uniprocessor system including one processor 10 or a multiprocessor system including several processors 10 (e.g., two, four, eight or another suitable number). Processors 10 may be any suitable processors capable of executing instructions. For example, in various embodiments, processors 10 may be general-purpose or embedded processors implementing any of a variety of instruction set architectures (ISAs), such as the x86, PowerPC, SPARC or MIPS ISAs or any other suitable ISA. In multiprocessor systems, each of processors 10 may commonly, but not necessarily, implement the same ISA.

System memory 20 may be configured to store instructions and data accessible by processor(s) 10. In various embodiments, system memory 20 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 20 as code 25 and data 26.

In one embodiment, I/O interface 30 may be configured to coordinate I/O traffic between processor 10, system memory 20 and any peripherals in the device, including network interface 40 or other peripheral interfaces. In some embodiments, I/O interface 30 may perform any necessary protocol, timing or other data transformations to convert data signals from one component (e.g., system memory 20) into a format suitable for use by another component (e.g., processor 10). In some embodiments, I/O interface 30 may include support for devices attached through various types of peripheral buses, such as a variant of the Peripheral Component Interconnect (PCI) bus standard or the Universal Serial Bus (USB) standard, for example. In some embodiments, the function of I/O interface 30 may be split into two or more separate components, such as a north bridge and a south bridge, for example. Also, in some embodiments some or all of the functionality of I/O interface 30, such as an interface to system memory 20, may be incorporated directly into processor 10.

Network interface 40 may be configured to allow data to be exchanged between computing device 100 and other device or devices 60 attached to a network or networks 50, such as other computer systems or devices, for example. In various embodiments, network interface 40 may support communication via any suitable wired or wireless general data networks, such as types of Ethernet networks, for example. Additionally, network interface 40 may support communication via telecommunications/telephony networks, such as analog voice networks or digital fiber communications networks, via storage area networks such as Fibre Channel SANs (storage area networks) or via any other suitable type of network and/or protocol.

In some embodiments, system memory 20 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media—e.g., disk or DVD/CD coupled to computing device 100 via I/O interface 30. A non-transitory computer-accessible storage medium may also include any volatile or non-volatile media, such as RAM (e.g. SDRAM, DDR SDRAM, RDRAM, SRAM, etc.), ROM (read only memory) etc., that may be included in some embodiments of computing device 100 as system memory 20 or another type of memory. Further, a computer-accessible medium may include transmission media or signals such as electrical, electromagnetic or digital signals conveyed via a communication medium, such as a network and/or a wireless link, such as those that may be implemented via network interface 40. Portions or all of multiple computing devices, such as those illustrated in FIG. 2, may be used to implement the described functionality in various embodiments; for example, software components running on a variety of different devices and servers may collaborate to provide the functionality. In some embodiments, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

A compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

A network set up by an entity, such as a company or a public sector organization, to provide one or more web services (such as various types of cloud-based computing or storage) accessible via the Internet and/or other networks to a distributed set of clients may be termed a provider network. Such a provider network may include numerous data centers hosting various resource pools, such as collections of physical and/or virtualized computer servers, storage devices, networking equipment and the like, needed to implement and distribute the infrastructure and web services offered by the provider network. The resources may in some embodiments be offered to clients in various units related to the web service, such as an amount of storage capacity for storage, processing capability for processing, as instances, as sets of related services and the like. A virtual computing instance may, for example, comprise one or more servers with a specified computational capacity (which may be specified by indicating the type and number of CPUs, the main memory size and so on) and a specified software stack (e.g., a particular version of an operating system, which may in turn run on top of a hypervisor).

A number of different types of computing devices may be used singly or in combination to implement the resources of the provider network in different embodiments, including general-purpose or special-purpose computer servers, storage devices, network devices and the like. In some embodiments a client or user may be provided direct access to a resource instance, e.g., by giving a user an administrator login and password. In other embodiments the provider network operator may allow clients to specify execution requirements for specified client applications and schedule execution of the applications on behalf of the client on execution platforms (such as application server instances, Java™ virtual machines (JVMs), general-purpose or special-purpose operating systems, platforms that support various interpreted or compiled programming languages such as Ruby, Perl, Python, C, C++ and the like or high-performance computing platforms) suitable for the applications, without, for example, requiring the client to access an instance or an execution platform directly. A given execution platform may utilize one or more resource instances in some implementations; in other implementations, multiple execution platforms may be mapped to a single resource instance.

In many environments, operators of provider networks that implement different types of virtualized computing, storage and/or other network-accessible functionality may allow customers to reserve or purchase access to resources in various resource acquisition modes. The computing resource provider may provide facilities for customers to select and launch the desired computing resources, deploy application components to the computing resources and maintain an application executing in the environment. In addition, the computing resource provider may provide further facilities for the customer to quickly and easily scale up or scale down the numbers and types of resources allocated to the application, either manually or through automatic scaling, as demand for or capacity requirements of the application change. The computing resources provided by the computing resource provider may be made available in discrete units, which may be referred to as instances. An instance may represent a physical server hardware platform, a virtual machine instance executing on a server or some combination of the two. Various types and configurations of instances may be made available, including different sizes of resources executing different operating systems (OS) and/or hypervisors, and with various installed software applications, runtimes and the like. Instances may further be available in specific availability zones, representing a logical region, a fault tolerant region, a data center or other geographic location of the underlying computing hardware, for example. Instances may be copied within an availability zone or across availability zones to improve the redundancy of the instance, and instances may be migrated within a particular availability zone or across availability zones. As one example, the latency for client communications with a particular server in an availability zone may be less than the latency for client communications with a different server. As such, an instance may be migrated from the higher latency server to the lower latency server to improve the overall client experience.

In some embodiments the provider network may be organized into a plurality of geographical regions, and each region may include one or more availability zones. An availability zone (which may also be referred to as an availability container) in turn may comprise one or more distinct locations or data centers, configured in such a way that the resources in a given availability zone may be isolated or insulated from failures in other availability zones. That is, a failure in one availability zone may not be expected to result in a failure in any other availability zone. Thus, the availability profile of a resource instance is intended to be independent of the availability profile of a resource instance in a different availability zone. Clients may be able to protect their applications from failures at a single location by launching multiple application instances in respective availability zones. At the same time, in some implementations inexpensive and low latency network connectivity may be provided between resource instances that reside within the same geographical region (and network transmissions between resources of the same availability zone may be even faster).

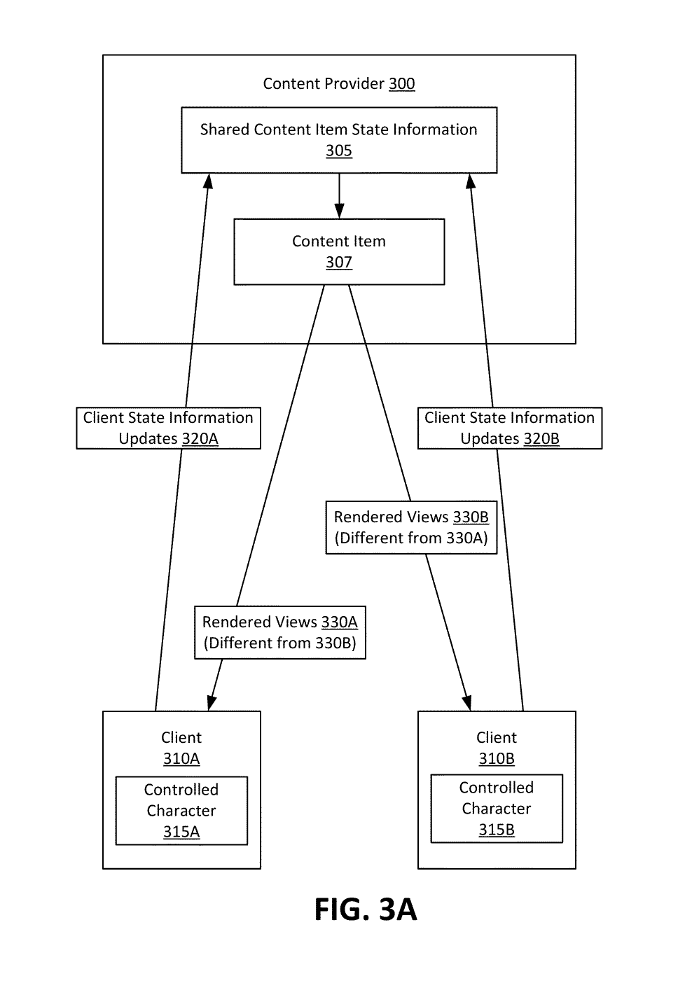

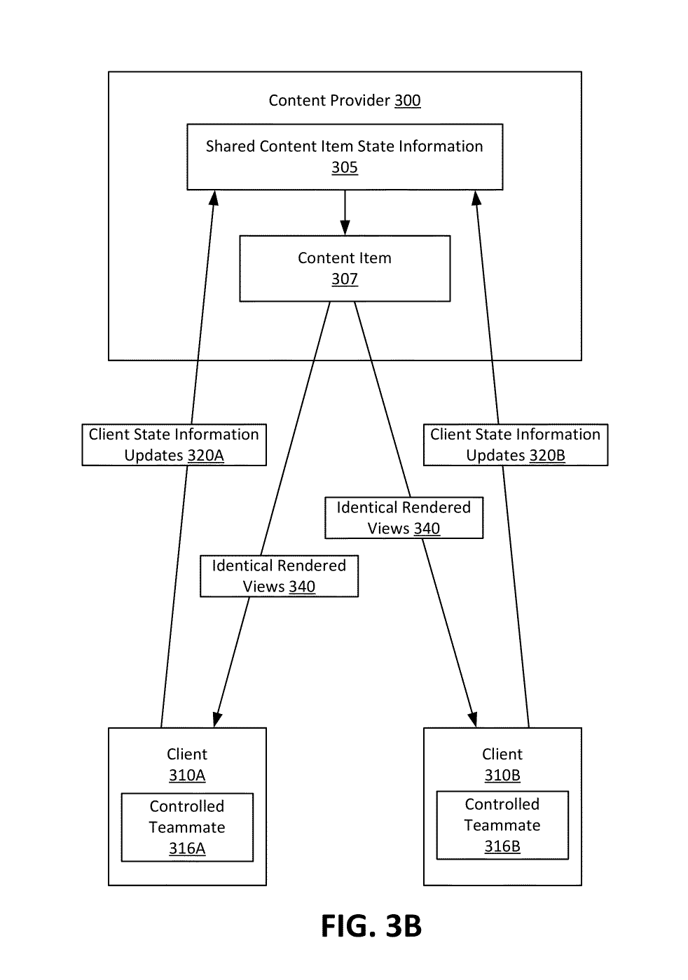

As set forth above, in some cases, multiple rendered views of a scene of a particular content item, such as a video game, may be generated by a content provider and transmitted from the content provider to multiple different clients. An example system for multiple view generation in accordance with the present disclosure is illustrated in FIG. 3A. As shown, FIG. 3A includes a content provider 300 in communication with clients 310A and 310B. Content provider 300 executes a content item 307. Content provider 300 may, for example, provide one or more content providing services for providing content to clients, such as clients 310A and 310B. The content providing services may reside on one or more servers. The content providing services may be scalable to meet the demands of one or more customers and may increase or decrease in capability based on the number and type of incoming client requests. Portions of content providing services may also be migrated to be placed in positions of reduced latency with requesting clients. Content provider 300 and some of its example architectures are described in greater detail below.

The term content, as used herein, refers to any presentable information, and the term content item, as used herein, refers to any collection of any such presentable information. For example, content item 307 may include graphics content such as a video game. In some cases, content item 307 may include two-dimensional content, which, as used herein, refers to content that may be represented in accordance with two-dimensional scenes. Also, in some cases, content item 307 may include three-dimensional content, which, as used herein, refers to content that may be represented in accordance with three-dimensional scenes. The two-dimensional or three-dimensional scenes may be considered logical representations in the sense that they may, for example, not physically occupy the areas that they are intended to logically model or represent. The term scene, as used herein, refers to a representation that may be used in association with generation of an image. A scene may, for example, include or otherwise be associated with information or data that describes the scene. To present content item 307, scenes associated with the content item 307 may be used to generate resulting images for display. The images may be generated by way of a process commonly referred to as rendering, which may incorporate concepts such as, for example, projection, reflection, lighting, shading and others. An image may include, for example, information associated with a displayable output, such as information associated with various pixel values and/or attributes. As will be described below, each generated image may, in some cases, correspond to a particular view of a scene.

Content item 307 may be displayed and otherwise presented to users at clients 310A and 310B. Clients 310A and 310B may communicate with content provider 300 via an electronic network, such as, for example, the Internet or another type of wide area network (WAN) or local area network (LAN). Clients 310A and 310B may, in some cases, be physically positioned at remote locations with respect to one another.

While FIG. 3A depicts two clients 310A and 310B, the disclosed techniques may be employed in association with any number of different participating clients that receive transmissions corresponding to content item 307. In some cases, one or more of the participating connected clients may operate in a hybrid mode in which, in addition to receiving one or more views from the content provider 300, the hybrid mode clients execute their own local version of content item 307 and generate their own local client streams. Each hybrid mode client may then combine, locally at the client, a received content provider stream of views with the local client stream to generate and display a hybrid content item stream. The hybrid mode may, for example, allow clients to receive a stream from the content provider 300 in addition to their local stream in good network conditions, while also allowing the clients to continue to use their own local streams in poor network conditions when the content provider stream may be unavailable. In order to allow the hybrid mode clients to keep their local state synchronized with the content provider's shared state, the content provider 300 may periodically send state information to each of the hybrid mode clients.

Certain clients may switch back and forth between the hybrid mode and a full stream mode, in which the clients receive only a content provider stream and do not generate a local client stream. Thus, in some cases, a single shared state may be maintained for a large group of clients. Within the large group, some clients may operate in hybrid mode, some clients may operate in full stream mode and some clients may switch between hybrid mode and full stream mode. Additionally, in some cases, the amount of data sent to each hybrid mode client may vary depending on factors such as a quality of a connection between the content provider and the client, which may be based on conditions such as bandwidth, throughput, latency, packet loss rates and the like. For example, for a first hybrid mode client that has a higher quality connection to the content provider 300, the content provider 300 may transmit to the first hybrid mode client a higher complexity view of a scene that includes a larger amount of data. By contrast, for a second hybrid mode client that has a lower quality connection to the content provider, the content provider 300 may transmit to the second hybrid mode client a lower complexity view of the same scene that includes a smaller amount of data. For example, the higher complexity view sent to the first hybrid mode client may include more detail textures, patterns, shapes and other features that may not be included in the lower complexity view sent to the second hybrid mode client.

Referring back to FIG. 3A, in some cases, clients 310A and 310B may be associated with one or more different respective entities corresponding to content item 307. Such entities may include, for example, various characters, vehicles, weapons, athletic equipment or any other entities corresponding to a video game or other content item. In some cases, the respective entities may be controlled by the clients with whom they are associated. However, the respective entities may be associated in any way with the client, such as, for example, by being selected by or for particular users of the clients. In the particular example of FIG. 3A, client 310A controls a respective controlled character 315A, while client 310B controls a respective controlled character 315B.

Clients 310A and 310B may collect respective client state information associated with the respective presentation of content item 307 at clients 310A and 310B. Client state information is any information associated with a state of a content item as it relates in any way to one or more clients. Client state information may include, for example, information corresponding to a state of various features, events, actions or operations associated with the presentation of content item 307 at clients 310A and 310B. In some cases, client state information may indicate various actions or operations performed by controlled characters 315A and 315B. It is noted, however, that client state information collected by each client 310 is not limited to information corresponding to characters or other entities controlled by each of the respective clients 310 and may include information corresponding to any aspect associated with content item 307.

As shown in FIG. 3A, client 310A may transmit its respective client state information updates 320A to content provider 300, while client 310B may transmit its respective state information updates 320B to content provider 300. Client state information updates 320A and 320B may be transmitted from clients 310A and 310B periodically at any appropriate scheduled or non-scheduled times. Client state information updates 320A may, for example, be transmitted at specified intervals or other times or in response to certain events. For example, a transmission of client state information updates 320A and 320B may be triggered by a character performing an action, such as moving to a specified location. There is no requirement that client state information updates 320A and 320B necessarily be sent simultaneously with one another. As should be appreciated, in some cases, as an alternative or in addition to transmitting updated client state information, one or more of clients 310A and 310B may transmit all client state information and/or some portion of previously transmitted client state information. For example, in some cases, the first transmission of state information from a particular client may include all client state information, while subsequent transmissions may include only updates or updates along with some portion of previously transmitted information.

Content provider 300 may receive client state information updates 320A and 320B and use the updates to adjust shared content item state information 305. The adjusting may include, for example, adding, deleting and/or modifying various portions of the shared content item state information 305. Shared content item state information 305 may then, for example, be used in combination with content item 307 to produce one or more content item scenes.

As an example, controlled character 315A may fire a loaded weapon and launch a bullet towards a particular doorway, while controlled character 315B may simultaneously enter into the same doorway and face controlled character 315A. Client 310A may send client state information updates 320A, which may indicate the firing of the weapon by controlled character 315A and the direction of the bullet. Client 310B may send client state information updates 320B, which may indicate the movement of controlled character 315B to enter the doorway. Content provider 300 may update shared content item state information 305 to indicate the received client state information updates 320A and 320B. Content item 307 may then access shared content item state information 305 to produce a subsequent content item scene in which controlled character 315B stands in the doorway with a bullet wound in his chest, while controlled character 315A stands facing the doorway from the position at which controlled character 315A fired his weapon.

Once a scene is produced in association with content item 307, content provider 300 may render the scene for display at clients 310A and 310B. In the particular example of FIG. 3A, content provider 300 generates multiple rendered views 330A and 330B. For example, as shown in FIG. 3A, content provider 300 may generate and transmit rendered views 330A to client 310A, while content provider 300 may also generate and transmit rendered views 330B to client 310B. Rendered views 330A and 330B are different from one another. A view, as that term is used herein, refers to a particular image associated with a scene. When multiple different views of a particular scene are generated, each of the multiple different views may include a different respective image that is generated based on the scene.

The rendered views 330A and 330B may, in some cases, be associated with one or more respective entities associated with clients 310A and 310B. For example, rendered views 330A may be associated with controlled character 315A, while rendered views 330B may be associated with controlled character 315B.

In some cases, the rendered views 330A and 330B may present a view of a scene from a perspective that corresponds to an associated respective entity. For example, rendered view 330A may depict a scene as it would be viewed through the eyes of controlled character 315A, while rendered view 330B may depict a scene as it would be viewed through the eyes of controlled character 315B. In other cases, the rendered views 330A and 330B may present a view of a scene, such that an associated respective entity is in the center of the view or is otherwise positioned at a location of high interest and/or high visibility within the view. For example, rendered view 330A may depict a scene, such that controlled character 315A is positioned in the center of the view, while rendered view 330B may depict a scene, such that controlled character 315B is positioned in the center of the view. As another example, if certain objects within a scene are blocking a view of an associated respective entity, then those objects may be removed from or otherwise adjusted within the rendered view.

Additionally, in some cases, certain modifications may be added or otherwise associated with a particular rendered view. For example, an associated respective character or other entity may be enlarged or highlighted for the purposes of drawing attention or increasing visibility. Furthermore, certain other entities within a view may be modified if they are somehow associated with a particular associated respective character or entity. For example, if an associated respective character is looking for a particular weapon, then that weapon could be enlarged or highlighted in a rendered view for the purposes of drawing attention to or increasing visibility of the weapon.

Referring back to the example scene described above in which controlled character 315A is looking into the doorway after firing his weapon towards the doorway, a rendered view 330A for client 310A may, for example, provide a view from a perspective associated with controlled character 315A. The rendered view 330A may, for example, depict the example scene as it would be viewed through the eyes of controlled character 315A. Thus, the rendered view 330A may, for example, depict controlled character 315B standing in the doorway with a bullet wound in his chest, as this is what would be seen by controlled character 315A.

By contrast, a rendered view 330B for client 310B may, for example, provide a view from a perspective associated with controlled character 315B. As described above, in the example scene, the controlled character 315B is standing in the doorway facing controlled character 315A that has just fired his weapon. The rendered view 330B may, for example, depict the example scene as it would be viewed through the eyes of controlled character 315B. Thus, the rendered view 330B may, for example, depict controlled character 315A with a recently fired weapon in his hand, as this is what would be seen by controlled character 315B.

In some cases, client state information updates 320A and 320B may include any information that may be used to assist in formation of rendered views 330A and 330B. Such information may include information indicating one or more respective entities associated with clients 310A and 310B. For example, FIG. 3A depicts controlled characters 315A and 315B as respective entities associated with clients 310A and 310B. Client state information updates 320A and 320B may also indicate, for example, any other entities that may be related in any way to clients 310A and 310B. Client state information updates 320A and 320B may also indicate, for example, if clients 310A and 310B switch control of various characters or entities or connect or disconnect from participation in a content transmission session. Client state information updates 320A and 320B may also indicate, for example, whether each of clients 310A and 310B is operating in a hybrid mode or a full stream mode and/or indicate a switch between operating in such modes. Any other appropriate information that may be used to assist in formation of rendered views 330A and 330B may also be included in client state information updates 320A and 320B, in any other collection of information transmitted to content provider 300 or, in some cases, in information that is stored by or otherwise available to content provider 300. For example, in some cases, content provider 300 may store information about clients 310A and 310B including, for example, an indication of characters or other entities controlled by clients 310A and 310B or any other appropriate information that may be used to assist in formation of rendered views 330A and 330B. In some cases, information that may be used to assist in formation of rendered views 330A and 330B may be included in shared content item state information 305.

Thus, as described above, a content provider may render and transmit multiple views of a content item to multiple different client devices. In some cases, however, it may be desirable to transmit identical views of a scene to multiple client devices. For example, it may be desirable to transmit an identical view to different clients with associated respective content item entities that are the same or are closely related. More specifically, for example, an identical view may sometimes be transmitted to different clients that collaborate to jointly control the same character. As another example, an identical view may sometimes be transmitted to different clients that control different but closely related characters, such as teammates or members of the same unit or organization. As yet another example, identical views may be transmitted when one or more clients operate in a spectator mode in which the spectator clients do not control any entities within the content item, while one or more other clients operate in an active mode in which they do control one or more entities within the content item. In some cases, one or more of the spectator mode clients may receive an identical view. Also, in some cases, one or more of the spectator mode clients and one or more of the active mode clients may receive an identical view. For example, a particular spectator mode client may have interest in a particular entity controlled by a particular active mode client and, therefore, may wish to receive the identical view that is sent to the particular active mode client. Identical views may also be transmitted based on any other appropriate reason or rationale.

An example system for identical view generation in accordance with the present disclosure is illustrated in FIG. 3B. In FIG. 3B, client 310A controls its respective controlled teammate 316A, while client 310B controls its respective controlled teammate 316B. As also shown in FIG. 3B, identical rendered views 340 are generated by content provider 300 and transmitted to both clients 310A and 310B. As set forth above, in some cases, it may be desirable for clients that control teammates to receive an identical view of a scene. It is noted, however, that there are many cases in which clients that control teammates may wish to receive different views. Also, as noted above, there may be a number of other circumstances in addition or as alternatives to controlling teammates in which clients 310A and 310B may receive an identical view.

It is further noted that any combination of identical and different views may also be generated and transmitted to any number of different clients. For example, for a content item that is being transmitted to three participating clients, two of the three clients may receive identical views, while the third client may receive a different view.

Additionally, it is noted that the configuration of clients as receiving identical or different views may change throughout a particular content item transmission session. For example, two clients may initially control two teammates and may receive identical views of a particular content item. However, at some point during transmission of the content item, one of the clients may relinquish control of its character and initiate control of a different character on an opposing team. In this case, after switching control of the character, the switching client may begin to receive a different view than is transmitted to the other client. As set forth above, the switching of characters or any other view-related information may, in some cases, be communicated from a client to a content provider as part of client state information updates or using any other appropriate technique.

It is further noted that it may not be necessary to specifically designate any particular clients as receiving different views or identical views with respect to one another. Rather, in some cases, views for each client may be generated based on information associated with the client, such as respective entities or any other appropriate information. Thus, in some cases, two clients may receive different views of some scenes and identical or near-identical views of other scenes without necessarily designating such views as similar or identical. For example, in some cases, two unrelated characters controlled by two different clients may happen to be positioned in close proximity to one another within a particular scene. In such cases, identical or near-identical views of that particular scene may sometimes be transmitted to the two different clients. By contrast, for other scenes where the unrelated characters are not positioned in close proximity to one another, the same two clients may receive different views.

Thus, a number of techniques for rendering one or more views at a content provider based on shared state information are set forth above. Rendering of the one or more views at the content provider, may, in some cases, reduce or eliminate any need to send state information from the content provider to the clients. Additionally, rendering of the one or more views at the content provider may, in some cases, reduce the cost, complexity and usage requirements of content presentation software installed on the client devices. This may, for example, sometimes allow content to be presented on the client devices using thin client content presentation software as opposed to thick client content presentation software. Furthermore rendering of the one or more views at the content provider may, in some cases, reduce piracy and other security concerns for creators and distributors of the content.

Additionally, it is noted that an amount or quantity of virtual machine instances and/or other resources used to execute a content item need not necessarily be dependent on a number of views generated in association with a content item. For example, in some cases, a single virtual machine instance may be employed to execute a content item with multiple different rendered views being transmitted to multiple different clients. In some cases, however, multiple virtual machine instances may be employed if desired, for example, to reduce latency.

In addition to rendering of one or more views at a content provider, the disclosed techniques may also enable multiple graphics processing units to be employed in association with a particular content item. In some cases, the multiple graphics processing units may generate renderings associated with a particular scene at least partially simultaneously with one another. A rendering refers to data that is generated at least in part by one or more graphics processing units and that is associated with at least a portion of one or more images. Also, in some cases, the use of multiple graphics processing units may assist in enabling real time or near-real time generation and presentation of rendered views. The multiple graphics processing units may, in some cases, be distributed across any number of different machines or devices at any number of different physical locations. In some cases, multiple graphics processing units may be used to render only a single view of a scene, while, in other cases, multiple graphics processing units may be used to render multiple views of a scene. It is noted, however, that multiple graphics processing units are not necessarily required to render multiple views of a scene. In some cases, a single graphics processing unit may be sufficient to render multiple views of a scene.

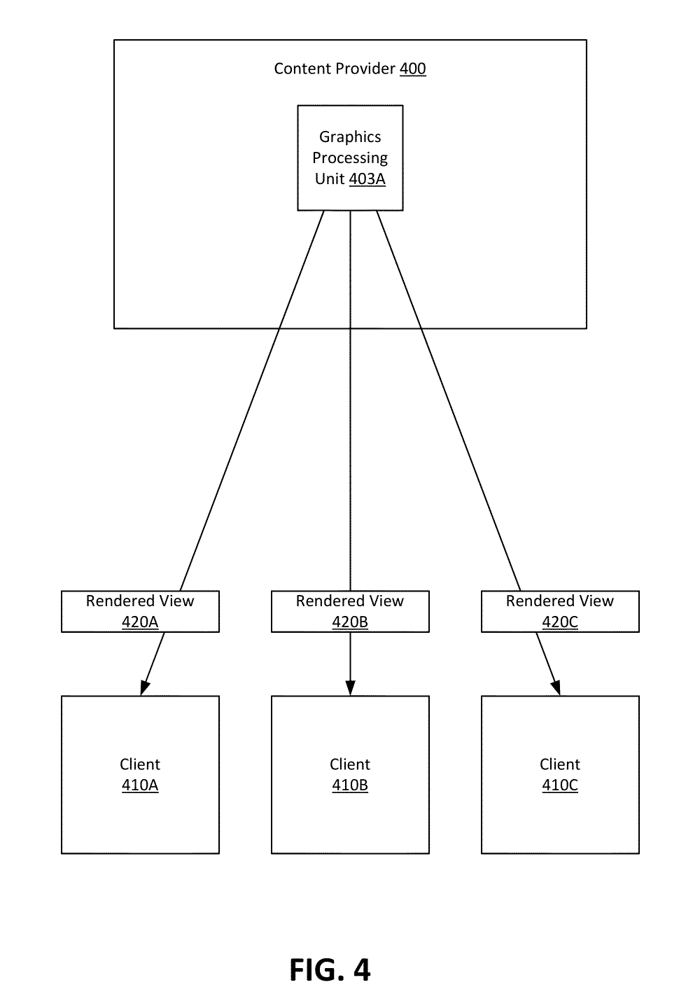

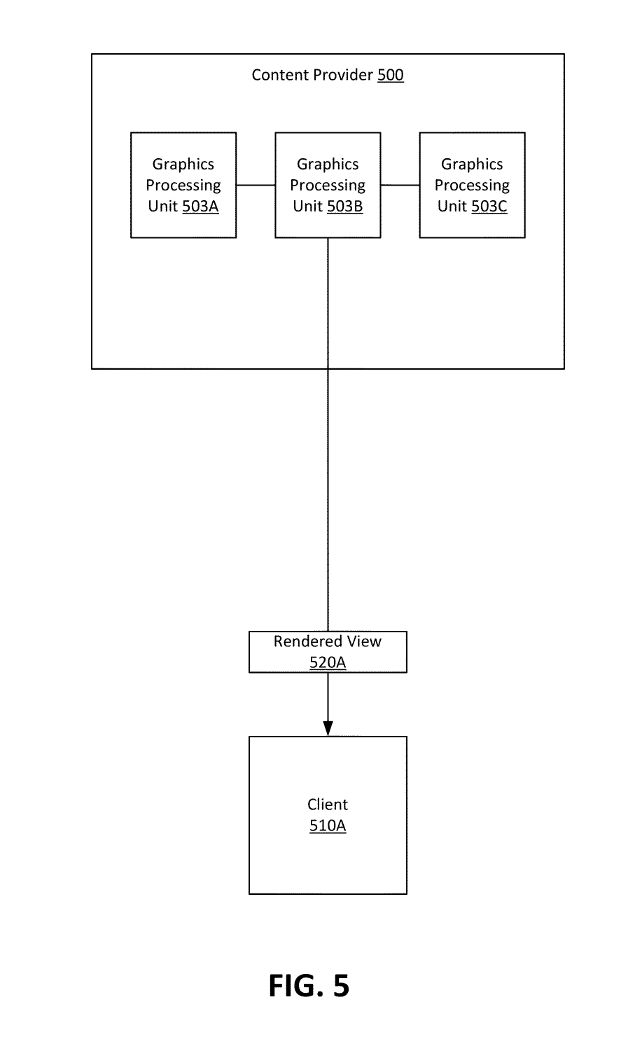

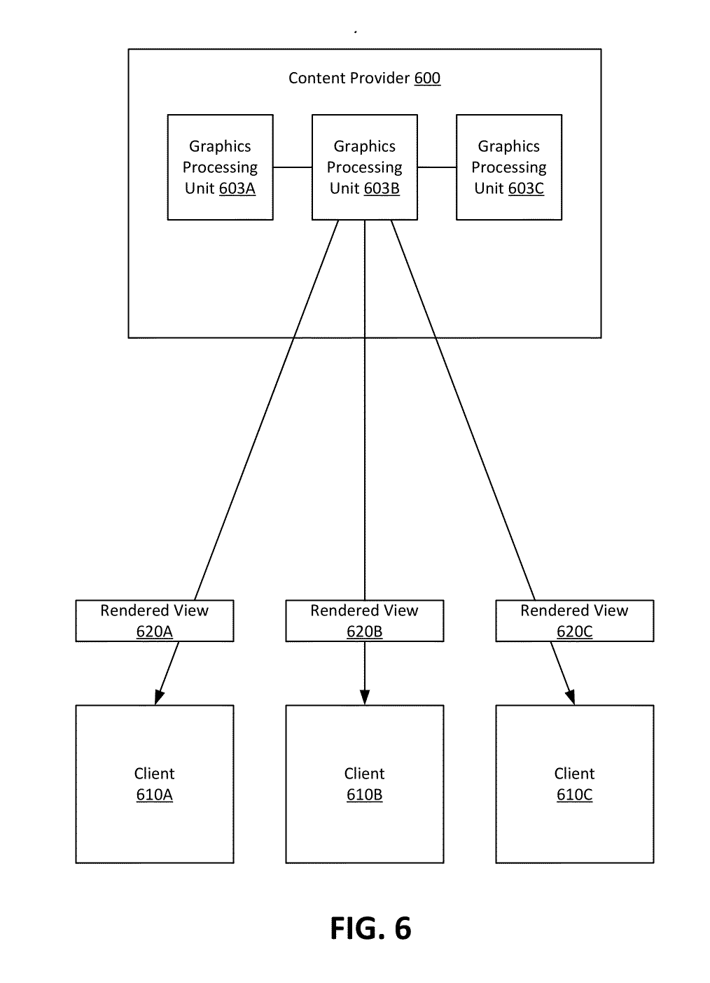

Some example content transmission systems that depict various interactions between the above described concepts of multiple views and multiple graphics processing units are illustrated in FIGS. 4-6. In particular, FIG. 4 depicts the example scenario in which a single graphics processing unit is employed to generate multiple views. As shown in FIG. 4, content provider 400 includes graphics processing unit 403A that generates rendered views 420A, 420B and 420C, which are transmitted, respectively, to clients 410A, 410B and 410C. FIG. 5 depicts the example scenario in which multiple graphics processing units are employed to generate a single view. As shown in FIG. 5, content provider 500 includes graphics processing units 503A, 503B and 503C that combine to generate rendered view 520A, which is transmitted to client 510A. FIG. 6 depicts an example scenario in which multiple graphics processing units are employed to generate multiple views. As shown in FIG. 6, content provider 600 includes graphics processing units 603A, 603B and 603C that are employed to generate rendered views 620A, 620B and 620C, which are transmitted, respectively, to clients 610A, 610B and 610C. In some other example configurations, each graphics processing unit 603A-C may generate a respective rendered view 620A-C. For example, graphics processing unit 603A may generate rendered view 620A, graphics processing unit 603B may generate rendered view 620B, and graphics processing unit 603C may generate rendered view 620C. In yet other cases, two or more of graphics processing units 603A-C may combine to generate one or more of rendered views 620A-C. For example, graphics processing units 603A and 603B may combine to form rendered views 620A and 620B, while graphics processing unit 603C may separately generate rendered view 620C.

Any number of appropriate techniques may be employed to distribute rendering of a scene across multiple graphics processing units. For example, in some cases, each of the multiple graphics processing units may be assigned a respective portion of the scene for rendering. Each portion of the scene may include, for example, an area of the scene indicated by various coordinates, dimensions or other indicators. For example, in some cases, a scene distributed across two graphics processing units may be divided into two equal sized halves, with each half assigned to a respective one of the two graphics processing units.

As another example, a scene may include multiple objects—such as characters, buildings, vehicles, weapons, trees, water, fire, animals and others. In some cases, each of the multiple graphics processing units may be assigned a respective object, portion of an object or collection of objects within the scene for rendering. The term object, as used herein, refers to any portion of a scene, image or other collection of information. An object may be, for example, a particular pixel or collection of pixels. An object may be, for example, all or any portion of a particular asset. An object may also be, for example, all or any portion of a collection of assets. An object may also be, for example, all or any portion of an entity such as a tree, fire, water, a cloud, a cloth, clothing, a human, an animal and others. For example, an object may be a portion of a tree. An object may also, for example, include all or any portion of a collection of objects, entities and/or assets. For example, an object may be a group of multiple trees or clouds that may be located, for example, at any location with respect to one another.

As another example, if multiple views of a scene are being generated, then, in some cases, each of the multiple graphics processing units may be assigned one or more respective views of the scene for rendering. Any combination of the example techniques described above and/or any other appropriate techniques may be employed to distribute rendering of a scene across multiple graphics processing units.

In some cases, the number of graphics processing units that are used to render a particular content item may be elastic, such that the number changes depending on various factors. Such factors may include, for example, a rate at which a graphics processing unit generates renderings or other performance rates of one or more graphics processing units, a complexity of rendered scenes, a number of views associated with the rendered scenes, availability of additional graphics processing units and any combination of these or other relevant factors.

In some cases, the performance rate of one or more graphics processing units associated with rendering of a particular content item may be monitored to determine an efficiency at which the graphics processing units are performing. For example, in some cases, if a graphics processing unit is rendering scenes or portions of scenes below a certain threshold performance rate, then a decision may be made to add one or more additional graphics processing units to assist in rendering of the scenes or portions of scenes. By contrast, in some cases, if two or more graphics processing units are rendering portions of scenes above a certain threshold performance rate, then a decision may be made to relinquish one or more of those graphics processing units such that they can be made available to assist with other content items or content provider tasks.

There are a number of factors that may affect the rendering rate of one or more graphics processing units. One such example factor may be scene complexity. For example, in some cases, a scene complexity associated with a particular content item may vary from one scene to the next. Any number of different factors may be responsible for such a change in scene complexity. In some cases, certain objects or portions of objects may be added or removed or otherwise adjusted, obscured or made visible. For example, scene complexity may be increased from one scene to the next when certain characters, buildings, vehicles or other objects are added into the subsequent scene. In some cases, when scene complexity is increased, one or more graphics processing units may become overburdened such that they can no longer efficiently render their respective scenes or scene portions. By contrast, in some cases, when scene complexity is reduced, one or more graphics processing units may gain additional available capacity such that the number of graphics processing units used to render the content item may be consolidated and reduced.

Another example factor that may affect the performance rate of one or more graphics processing units is a number of views associated with various scenes or portions of scenes. For example, when one or more client-controlled characters enter a particular portion of a scene, then the number of views associated with that portion of the scene may increase. This may occur, for example, when one or more client-controlled characters enter a particular building or room within a building. By contrast, when one or more client-controlled characters leave a particular portion of a scene, then the number of views associated with that portion of the scene may decrease. In some cases, when a number of views is increased, one or more graphics processing units may become overburdened such that they can no longer efficiently render their respective scenes or scene portions. By contrast, in some cases, when a number of views is decreased, one or more graphics processing units may gain additional available capacity such that the number of graphics processing units used to render the content item may be consolidated and reduced.

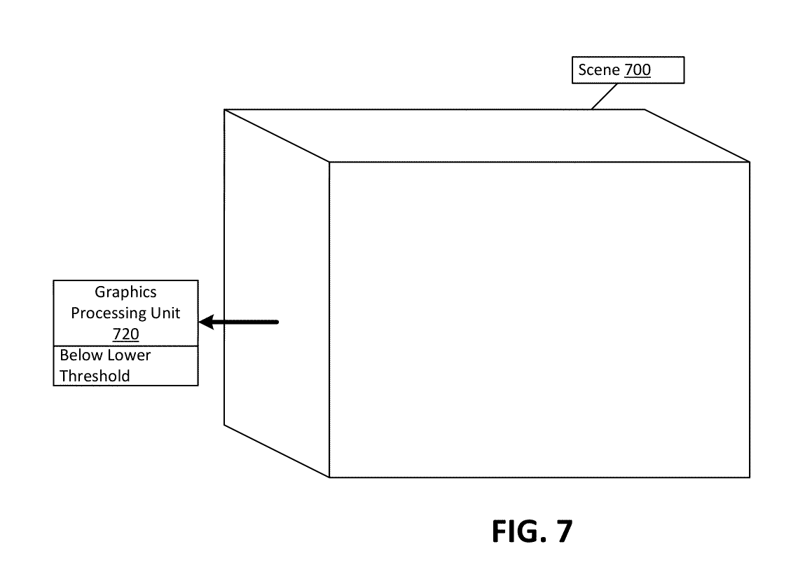

Some example scenarios that illustrate some of the above described graphics processing unit scaling concepts will now be described with respect to FIGS. 7-10. In particular, FIG. 7 illustrates a first example graphics processing unit scaling scenario in accordance with the disclosed techniques. In particular, FIG. 7 depicts a scene 700 rendered by a single graphics processing unit 720. It is noted that scene 700 is depicted in FIG. 7 as a three-dimensional scene (as indicated by its cubic form). However, the disclosed techniques are not limited to use with three-dimensional scenes and may also be used with, for example, two-dimensional scenes. FIG. 7 indicates that graphics processing unit 720 is operating below the lower threshold performance rate. As set forth above, this lower performance rate may be due to factors, such as a scene complexity that is too high and/or has too many associated views to be efficiently rendered by the single graphics processing unit 720. Accordingly, in some cases, a content provider may, based on graphics processing unit 720 operating below the lower threshold performance rate, determine that additional graphics processing units should be employed to render subsequent scenes.

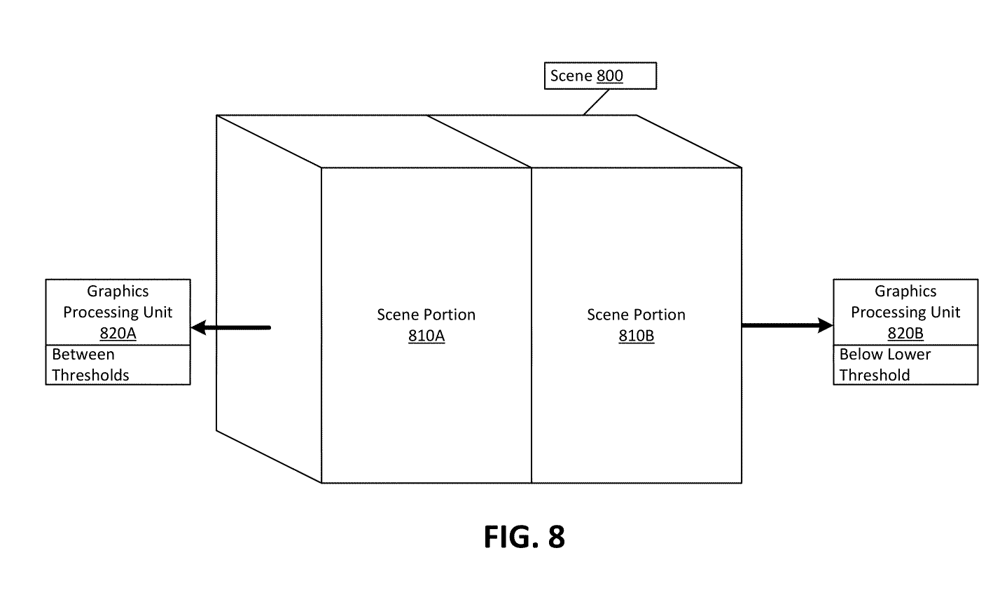

FIG. 8 depicts the scenario in which a content provider adds an additional graphics processing unit based on graphics processing unit 720 of FIG. 7 operating below the lower threshold performance rate. In particular, FIG. 8 depicts a scene 800, which is one or more scenes subsequent to scene 700 of FIG. 7. Scene 800 is divided into two scene portions 810A and 810B. Additionally, the rendering of scene 800 is distributed across two graphics processing units 820A and 820B. In particular, scene portion 810A is rendered by graphics processing unit 820A, while scene portion 810B is rendered by graphics processing unit 820B. It is noted that the rectangular shapes of scene portions 810A and 810B are selected merely for descriptive purposes and are not limiting. A scene may, in accordance with the disclosed techniques, be divided into any number of different portions having any number of different shapes or sizes. It is further noted that, when an additional graphics processing unit is being added, it is not necessarily required to divide portions of previous scenes into equal sized halves.

FIG. 8 indicates that graphics processing unit 820A is operating at a rate between the upper and lower threshold performance rates. Based on graphics processing unit 820A operating between the upper and lower thresholds, a content provider may, in some cases, determine no changes are necessary with respect to the graphics processing unit scaling of scene portion 810A. By contrast, FIG. 8 also indicates that graphics processing unit 820B is operating below the lower threshold performance rate. Accordingly, in some cases, a content provider may, based on graphics processing unit 820B operating below the lower threshold performance rate, determine that additional graphics processing units should be employed to render the area corresponding to scene portion 810B in subsequent scenes.

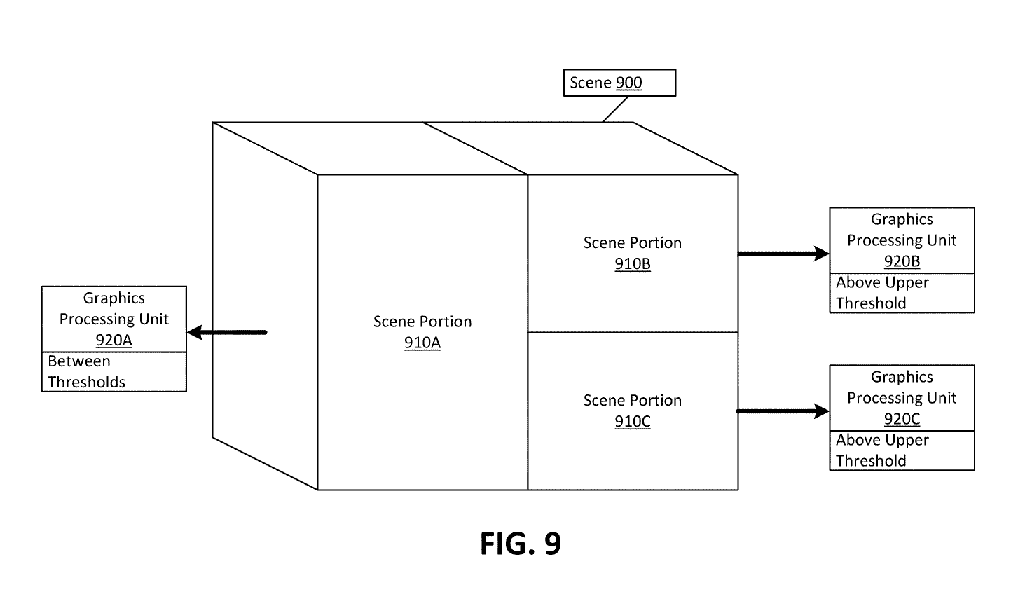

FIG. 9 depicts the scenario in which a content provider adds an additional graphics processing unit based on graphics processing unit 820B of FIG. 8 operating below the lower threshold performance rate. In particular, FIG. 9 depicts a scene 900, which is one or more scenes subsequent to scene 800 of FIG. 8. Scene 900 is divided into three scene portions 910A, 910B and 910C. Additionally, the rendering of scene 900 is distributed across three graphics processing units 920A, 920B and 920C. In particular, scene portion 910A is rendered by graphics processing unit 920A, scene portion 910B is rendered by graphics processing unit 920B and scene portion 910C is rendered by graphics processing unit 920C. It is noted that scene portions 910B and 910C were formed by dividing scene portion 810B of FIG. 8 into two equal half-portions. Scene portion 810B was divided because its respective graphics processing unit 820B was operating below the lower threshold performance rate.

FIG. 9 indicates that graphics processing unit 920A is operating at a rate between the upper and lower threshold performance rates. Based on graphics processing unit 920A operating between the upper and lower thresholds, a content provider may, in some cases, determine no changes are necessary with respect to the graphics processing unit scaling of scene portion 910A. By contrast, FIG. 9 also indicates that both graphics processing unit 920B and 920C are operating above the upper threshold performance rate. As set forth above, these higher performance rates may be due to factors, such as a lower scene complexity and/or a lower number of rendered views associated with respective scene portions 910B and 910C. Accordingly, in some cases, a content provider may, based on graphics processing units 920B and 920C operating above the upper threshold performance rate, determine that fewer graphics processing units should be employed to render the combined area corresponding to scene portions 910B and 910C in subsequent scenes.

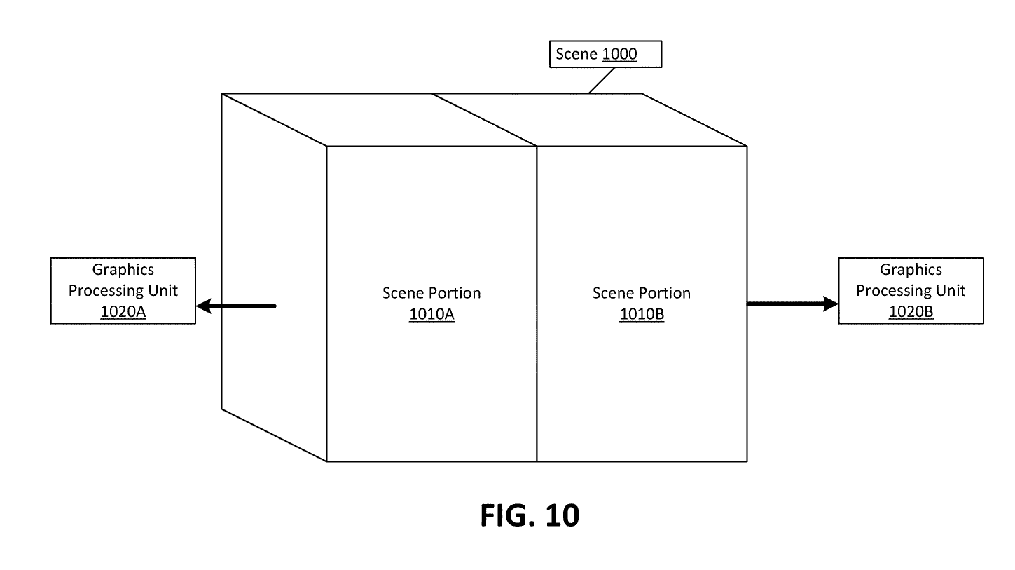

FIG. 10 depicts the scenario in which a content provider removes a graphics processing unit based on graphics processing units 920B and 920C of FIG. 9 operating above the upper threshold performance rate. In particular, FIG. 10 depicts a scene 1000, which is one or more scenes subsequent to scene 900 of FIG. 9. Scene 1000 is divided into two scene portions 1010A and 1010B. Additionally, the rendering of scene 1000 is distributed across two graphics processing units 1010A and 1010B. In particular, scene portion 1010A is rendered by graphics processing unit 1020A, while scene portion 1010B is rendered by graphics processing unit 1020B. It is noted that scene portion 1010B was formed by combining scene portions 910B and 910C of FIG. 9 into a single portion. Scene portions 910B and 910C were combined because their respective graphics processing units 920B and 920C were operating above the upper threshold performance rate. The combination of scene portions 910B and 910C may, in some cases, allow one of the two graphics processing units 920B or 920C to be re-assigned to another task that may have a greater need for an additional graphics processing unit.

It is once again noted that the scene portions and graphics processing unit distributions shown in FIGS. 7-10 are merely examples. The disclosed techniques may allow scenes to be divided into portions in any described manner. The disclosed techniques may also allow graphics processing units to be distributed across scenes or scene portions in any described manner.

As should be appreciated, there may be some cases in which, even though one or more graphics processing units are operating below the lower threshold performance rate, additional graphics processing units may not be available. This may be due to limited resources being available to the content provider. In such cases, for example, a request for one or more additional graphics processing units may be placed into a queue for obtaining additional graphics processing units when they become available. Additionally, for example, an urgency of the request may be determined based on factors, such as the extent to which the lower threshold performance rate is being undercut. In some cases, content items with the most urgent needs and/or lowest associated performance rates may receive newly available resources more quickly than other content items with less urgent needs. Furthermore, in some cases, while a content item is waiting for additional needed resources, the content item's existing assigned graphics processing units may be rearranged or otherwise reallocated in order to more efficiently render content item scenes.

While some of the above examples may include monitoring of graphics processing performance rates to achieve graphics processing unit scaling, it is noted that the disclosed techniques do not require and are not limited to the use of graphics processing unit monitoring. Rather, any appropriate technique may be employed in order to determine a desired number of graphics processing units to employ for scene rendering. For example, in some cases, a number of graphics processing units may be determined based, at least in part, on scene complexity information that may, for example, be associated with a particular content item and that may indicate a level of complexity associated with various portions of one or more scenes associated with the content item. Additionally, in some cases, a number of graphics processing units may be determined, at least in part, by monitoring a number of clients that are participating in the transmission of a particular content item and/or by monitoring or otherwise determining a number of different views that are being rendered in association with the transmission of a particular content item. Furthermore, in some cases, a number of graphics processing units may be determined, at least in part, based on any particular rules or preferences set by a particular content provider or any customer or other entity associated with a content provider. Any combination of these or other appropriate techniques may also be employed.

While some of the example graphics processing unit distribution techniques may involve assigning one or more portions of a scene to a single graphics processing unit, it is not required that each portion of a scene be assigned to one and only one graphics processing unit for rendering. In some cases, multiple graphics processing units may collaborate to collectively render a complete scene or any portion of a scene.

Thus, a number of example techniques for distributing rendering of a scene across multiple graphics processing units are described in detail above. In some cases, after different portions of a scene are rendered by multiple graphics processing units, all or portions of the various different renderings may be combined to form one or more resulting views for transmission and display. The content provider may employ various techniques for combining renderings received from multiple graphics processing units into each view. One example combination technique, which is referred to herein as a stitching technique, may involve inserting various renderings from different graphics processing units into different identified areas within a view. For example, a first rendering by a first graphics processing unit may be inserted at a first identified view area, while a second rendering by a second graphics processing unit may be inserted at a second identified view area. Each view area may be identified using, for example, coordinate values identified based on the scene from which the view is generated.

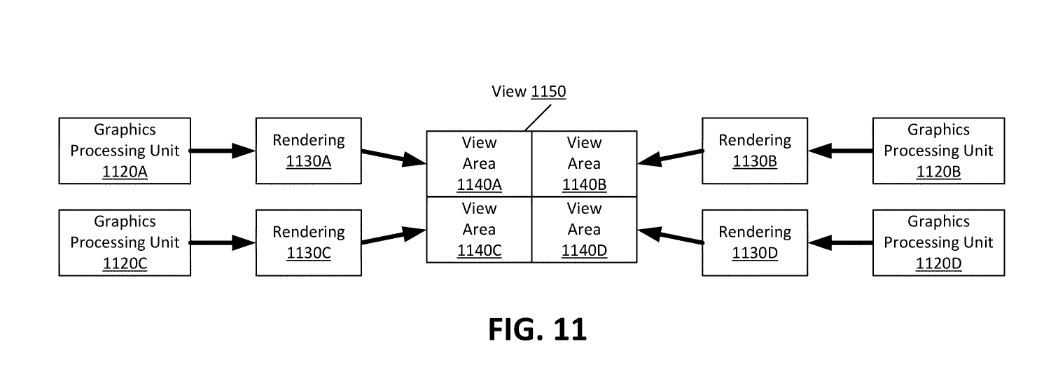

An example depiction of the stitching technique is illustrated in FIG. 11. In particular, FIG. 11 depicts four renderings 1130A-1130D generated by four different graphics processing units 1120A-D. In particular, rendering 1130A is generated by graphics processing unit 1120A, rendering 1130B is generated by graphics processing unit 1120B, rendering 1130C is generated by graphics processing unit 1120C and rendering 1130D is generated by graphics processing unit 1120D. As shown in FIG. 11, to form view 1150, rendering 1130A is inserted into view area 1140A, rendering 1130B is inserted into view area 1140B, rendering 1130C is inserted into view area 1140C and rendering 1130D is inserted into view area 1140D.

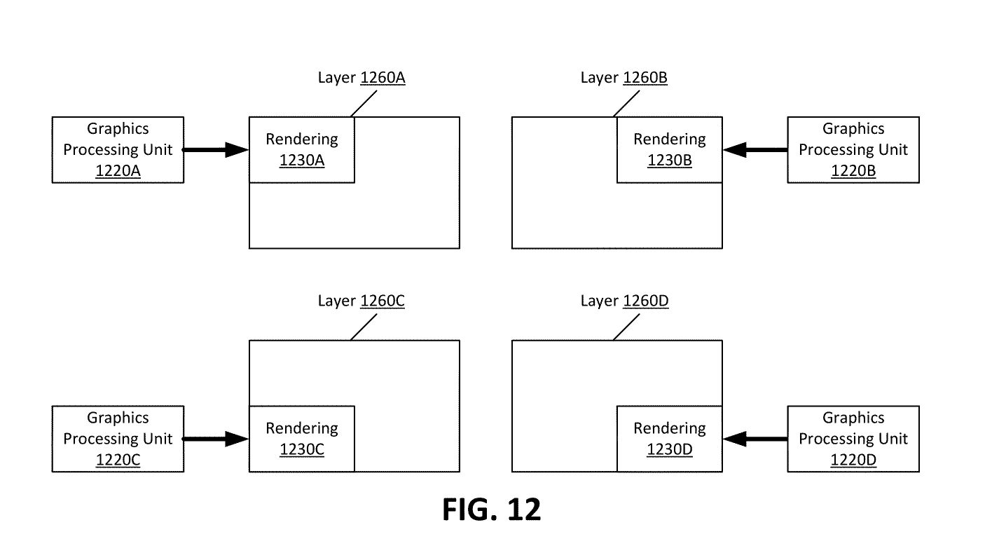

Another example combination technique, which is referred to herein as a layering technique, may employ a view representation having multiple layers. Each layer of the representation may correspond to a respective portion of the view. For example, a first layer may include a first portion of the view rendered by a first graphics processing unit, while a second layer may include a second portion of the view rendered by a second graphics processing unit. In particular, FIG. 12 depicts four layers 1260A, 1260B, 1260C and 1260D. Layer 1260A includes rendering 1230A received from graphics processing unit 1220A. Layer 1260B includes rendering 1230B received from graphics processing unit 1220B. Layer 1260C includes rendering 1230C received from graphics processing unit 1220C. Layer 1260D includes rendering 1230D received from graphics processing unit 1220D.

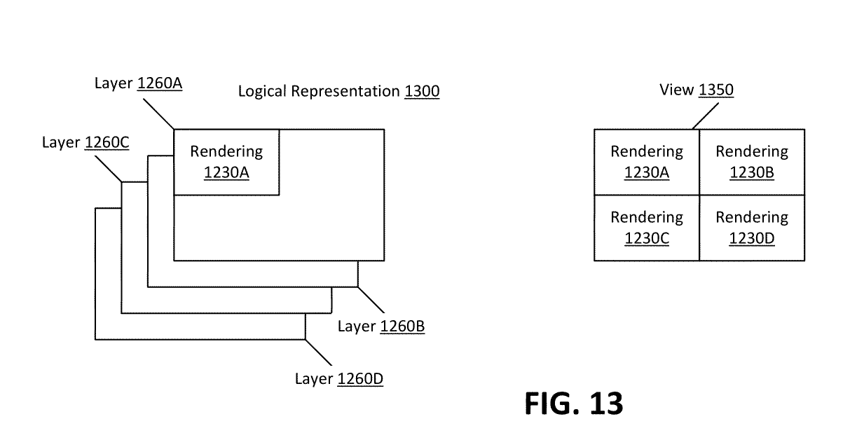

An example depiction of the layering technique is illustrated in FIG. 13. In particular, a logical representation 1300 is shown, in which layers 1260A-D are logically represented as being stacked vertically with layer 1260D at the bottom, layer 1260C second to the bottom, layer 1260B third from the bottom and layer 1260A on the top. It is noted that logical representation 1300 is not intended to be a physical structure in which layers 1260A-D are physically stacked on top and beneath each other. Rather, logical representation 1300 is merely a logical representation that is intended to indicate an example manner in which data corresponding to various portions of a view may be logically associated. Additionally, it should be appreciated that the example order of placement of layers shown in FIG. 13 is merely provided for illustrative purposes and is non-limiting. Referring back to FIG. 13, it is shown that logical representation 1300 is used to generate a resulting view 1350 that includes renderings 1230A-D.

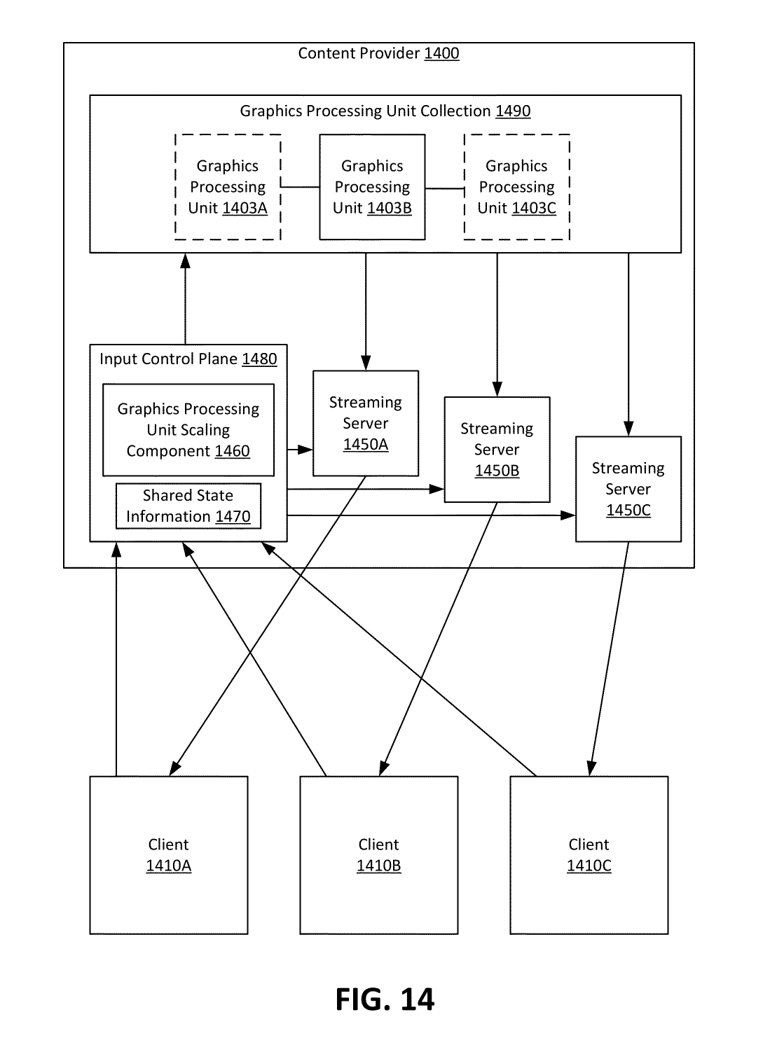

Thus, various techniques are set forth above for generating one or more views of a scene using one or more graphics processing units. An example content provider system in accordance with the disclosed techniques is depicted in FIG. 14. As shown, FIG. 14 includes clients 1410A-C in communication with content provider 1400. Clients 1410A-C may, for example, each participate in a transmission session of a particular content item, such as a video game. Clients 1410A-C may, for example, include active clients and spectator clients. Active clients are clients that control one or more characters or other entities within the content item. Spectator clients are clients that do not control any characters or other entities within the content item. Clients 1410A-C each receive a transmission of rendered content item views from a respective one of three streaming servers 1450A-C. It is noted, however, that, while streaming servers 1450A-C are included in the particular example of FIG. 14, the disclosed techniques are not limited to the use of streaming content transmission and may employ any other appropriate form of content delivery. The use of a separate respective streaming server 1450A-C for transmission of content to each client 1410A-C may be advantageous, for example, because it may, in some cases, enable improved ability to adjust various transmission characteristics to individual clients based on factors, such as the quality of service associated with a network connection to each client. The adjusted transmission characteristics may include, for example, encoding rates, transmission speed, image quality and other relevant factors. It is noted, however, that the disclosed techniques are not limited to the use of streaming technology or to the use of separate servers for transmission to each client. Rather, any number of servers may be employed in accordance with the present techniques for transmission to any number of different clients.

Each of clients 1410A-C may periodically send client state information updates to content provider 1400. In some cases, content provider 1400 may receive state information only from active clients and not from spectator clients. As set forth above, the client state information updates may include, for example, information corresponding to a state of various features, events, actions or operations associated with the presentation of a content item at each of clients 1410A-C. For example, the client state information updates may indicate various actions or operations performed by characters or other entities controlled by clients 1410A-C. As another example, the client state information updates may include any information that may assist in generating one or more views of a scene, such as an indication of characters or other entities controlled by a client, information regarding a switching of control from one character or entity to another and information regarding a connection or disconnection of a client form participation in a content transmission session. The client state information updates may also indicate, for example, whether each of clients 1410A-C is operating in a hybrid mode or a full stream mode and/or indicate a switch between operating in such modes.

Client state information updates transmitted from clients 1410A-C are received at content provider 1400 by input control plane 1480. The received state information from each client 1410A-C may be collectively used to adjust shared state information 1470 for the content item being transmitted. The adjusting may include, for example, adding, deleting and/or modifying various portions of shared state information 1470. As set forth above, the shared state information 1470 may be used in combination with the content item to produce various content item scenes. As also set forth above, the shared state information 1470 may also be used in combination with the content item to produce one or more views of each content item scene.

Each content item scene may then be rendered into one or more views by graphics processing unit collection 1490, which may include one or more graphics processing units 1403A-C. To indicate that graphics processing unit collection 1490 may include one or more graphics processing units, FIG. 14 depicts one graphics processing unit 1403B with a solid border, and the remaining graphics processing units 1403A and 1403C with dashed borders. The multiple graphics processing units 1403A-C may, in some cases, be distributed across any number of different machines or devices at any number of different physical locations. The number of graphics processing units 1403A-C used in association with a particular content item may be determined, at least in part, by graphics processing unit scaling component 1460. As set forth above, in some cases, the number of graphics processing units that are used to render a particular content item may be elastic such that the number may change from scene-to-scene or at any appropriate interval. A number of example techniques for determining an appropriate number of graphics processing units to employ are described in detail above.

Graphics processing unit scaling component 1460 may, in some cases, monitor, command and otherwise communicate with graphics processing unit collection 1490. For example, graphics processing unit scaling component 1460 may, as set forth above, monitor various workloads, available capacities, rates at which graphics processing units generate renderings and other performance rates and any other appropriate characteristics associated with graphics processing units 1403A-C. Graphics processing unit scaling component 1460 may also, in some cases, communicate with input control plane 1480, shared state information 1470, various content items and various other components in order to determine information, such as scene complexity, a number of connected clients and associated views, associated content provider or customer rules or preferences and any other relevant information. In the particular example of FIG. 14, graphics processing unit scaling component 1460 is included within input control plane 1480, but graphics processing unit scaling component 1460 may, in some cases, also be a separate component or be included as part of one or more other components.

In addition to determining a number of graphics processing units 1403 that will participate in the rendering of a particular content item, graphics processing unit scaling component 1460 may also, in some cases, determine how a total scene rendering load is distributed across the total number of participating graphics processing units 1403. For example, graphics processing unit scaling component 1460 may assign one or more particular graphics processing units to render particular portions of a scene. Some example distributions of various scene portions among various graphics processing units are illustrated in FIGS. 7-10 and described in detail above. As set forth above, in some cases, one or more graphics processing units may be assigned to render particular dimensions or coordinates of a scene, particular views of a scene and/or one or more scene objects such as characters, buildings, vehicles, weapons, trees, water, fire, animals and others. In some cases, in addition or as an alternative to graphics processing unit scaling component 1460, all or some of the graphics processing unit rendering distribution determinations may be made by other components, such as one or more of the graphics processing units 1403A-C or any other of the components depicted in FIG. 14 or other components.

As set forth above, once various portions of a scene have been rendered by one or more graphics processing units 1403A-C, the various renderings may be combined to form one or more resulting views. The combination of these different renderings may, in some cases, be performed by one or more of the graphics processing units 1403A-C and/or by any other appropriate components. Various example techniques for combining renderings from multiple graphics processing units, such as stitching and layering techniques, are illustrated in FIGS. 11-13 and described in detail above.

The one or more rendered views may then be provided to streaming servers 1450A-C for transmission to respective clients 1410A-C. Prior to transmission, various operations may be performed to prepare the rendered views for transmission, such as encoding and compression. These various operations may be performed by components within streaming servers 1450A-C or by various other components.

As set forth above, in some cases, at least some of clients 1410A-C may receive different views of a particular scene. Also, in some cases, at least some of clients 1410A-C may receive identical views of a particular scene. For example, clients 1410A and 1410B may receive identical views of a scene, while client 1410C may receive a different view of the same scene.

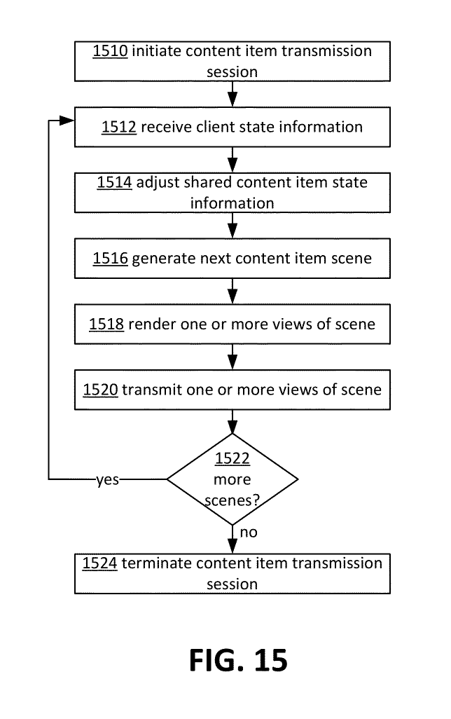

FIG. 15 is a flowchart depicting an example procedure for generating one or more views based on shared state information in accordance with the present disclosure. At operation 1510, a content item transmission session is initiated. The content item transmission session may, in some cases, be initiated based on one or more requests from one or more participating client devices. The participating client devices may, for example, include any client devices that receive one or more transmissions associated with the content item. The participating client devices may, for example, include active clients and spectator clients. Active clients are clients that control one or more characters or other entities within the content item. Spectator clients are clients that do not control any characters or other entities within the content item. As set forth above, the content item may be transmitted using multimedia streaming or any other appropriate content delivery technology.

At operation 1512, client state information is received by a content provider from one or more of the participating client devices. In some cases, the content provider may receive state information only from active clients and not from spectator clients. In some cases, the client state information received at operation 1512 may include all client state information from a particular client or only a portion of client state information from a particular client. For example, in some cases, the client state information received at operation 1512 may include a client state information update. Such a client state information update may, for example, include client state information not previously transmitted to the content provider. A client state information update may also, for example, exclude client state information previously transmitted to the content provider.

As set forth above, client state information may include, for example, information corresponding to a state of various features, events, actions or operations associated with the presentation of a content item at each participating client device. For example, client state information may indicate various actions or operations performed by characters or other entities controlled by a client. As another example, client state information may include any information that may assist in generating one or more views of a scene, such as an indication of characters or other entities controlled by a client, information regarding a switching of control from one character or entity to another and information regarding a connection or disconnection of a client form participation in a content transmission session. As yet another example, the client state information updates may also indicate, for example, whether a client is operating in a hybrid mode or a full stream mode and/or indicate a switch between operating in such modes.

At operation 1514, the content provider uses the client state information received at operation 1512 to adjust shared content item state information maintained by the content provider. The adjusting performed at operation 1514 may include, for example, adding, deleting and/or modifying various portions of shared content item state information. As set forth above, the shared content item state information may, in some cases, reflect the collective content item state based on the most recently received updated information from each connected client.

At operation 1516, a next content item scene is generated. As set forth above, the next content item scene may be generated based on, for example, information within the content item itself and also the shared content item state information maintained by the content provider.

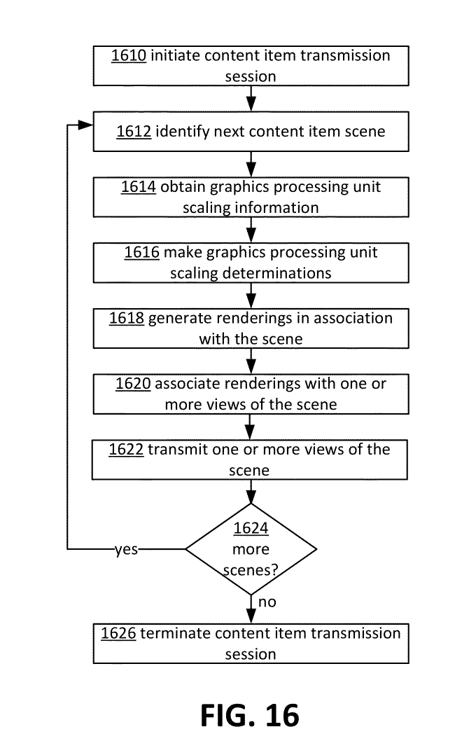

It is noted here that FIGS. 15 and 16 merely depict some example orders in which operations may be performed and are non-limiting. Thus, for example, while FIG. 15 depicts operations 1512 and 1514 as occurring prior to operation 1516, it is not required that these operations be performed in this order in any, each or every case. In particular, as set forth above, client state information updates may be received simultaneously or non-simultaneously from one or more participating clients periodically at any appropriate scheduled or non-scheduled times. Thus, for example, it is not required that client state information updates be received from any or every client and/or that shared state information be updated prior to every instance of a generation of a new scene.

At operation 1518, the content provider renders one or more views of the scene generated at operation 1516. As set forth above, each view of the scene may be a different image associated with the same scene. The one or more views of the scene may be rendered based on, for example, information within the content item itself and also the shared content item state information maintained by the content provider. As also set forth above, in some cases, at least some participating clients may receive different views of the same scene. Also, in some cases, at least some participating clients may receive an identical view of the same scene.

As set forth above, multiple different views of a scene may, for example, each depict the scene from a different respective perspective associated with each view. Each view may, for example, be generated from the perspective of one or more respective content item entities. The respective entities may, for example, be controlled by or otherwise associated with the one or more clients to whom the rendered view is transmitted. The respective entities may include, for example, characters, vehicles or any other entity associated with a content item scene. For example, in some cases, a perspective associated with a view may depict a scene as would be viewed through the eyes of a respective character or from another position associated with a respective entity. As another example, a perspective associated with a view may depict a scene such that a respective character or other entity is in the center of the view or is otherwise positioned at a location of high interest and/or high visibility within the view.

At operation 1520, each of the rendered views is transmitted by the content provider to the participating clients. As set forth above, in some cases, a different respective streaming server may be employed for transmissions to a respective client. At operation 1522, it is determined if there are any remaining scenes for generation in association with the content item being transmitted. If so, then the process returns to operation 1512. By contrast, if no scenes remain for generation, then transmission of the content item is terminated at operation 1524.

As also set forth above, in some cases, multiple different views may be generated for multiple different hybrid mode clients. In such cases, the amount of data sent to each hybrid mode client may sometimes vary depending on factors such as a quality of a connection between the content provider and the client, which may be based on conditions such as bandwidth, throughput, latency, packet loss rates and the like. For example, for a first hybrid mode client that has a higher quality connection to the content provider, the content provider may transmit to the first hybrid mode client a higher complexity view of a scene that includes a larger amount of data. By contrast, for a second hybrid mode client that has a lower quality connection to the content provider, the content provider may transmit to the second hybrid mode client a lower complexity view of the same scene that includes a smaller amount of data. For example, the higher complexity view sent to the first hybrid mode client may include more detail textures, patterns, shapes and other features that may not be included in the lower complexity view sent to the second hybrid mode client.

FIG. 16 is a flowchart depicting an example procedure for rendering using one or more graphics processing units in accordance with the present disclosure. At operation 1610, a content item transmission session is initiated. As set forth above, the content item transmission session may, in some cases, be initiated based upon one or more requests from one or more participating client devices and may employ, for example, multimedia streaming or any other appropriate content delivery technology. As set forth above, the participating client devices may, for example, include active clients and spectator clients. At operation 1612, a next content item scene is identified. As set forth above, the next content item scene may be generated based on, for example, information within the content item itself and also shared content item state information maintained by the content provider. Some example techniques for obtaining and updating shared content item state information are described in detail above. The generated content item scene may, for example, be identified by any combination of one or more graphics processing units, by a graphics processing unit scaling component or by any other appropriate component. The scene may, for example, be identified so that it can be accessed and rendered at least in part by one or more graphics processing units.

At operation 1614, graphics processing unit scaling information is obtained. The graphics processing unit scaling information obtained at operation 1614 may include any information associated with graphics processing unit scaling operations. As set forth above, such information may include, for example, a rate at which a graphics processing unit generates renderings or other performance rate associated with one or more graphics processing units, information regarding a number of clients participating in the content item transmission session, information regarding a number of different views being rendered in association with the content item transmission session, information regarding availability of additional graphics processing units or other resources, rules or preferences associated with a content provider and/or customer and any other appropriate information.

At operation 1616, one or more graphics processing unit scaling determinations are made. The graphics processing unit scaling determinations may, for example, be made based, at least in part, on the graphics processing unit scaling information obtained at operation 1614. The graphics processing unit scaling determinations may include, for example, determinations to employ one or more additional graphics processing units for rendering of the transmitted content item, to relinquish one or more graphics processing units from rendering of the transmitted content item and to otherwise re-distribute or re-assign one or more graphics processing units involved with rendering of the transmitted content item. The graphics processing unit scaling determinations may include, for example, determinations regarding a number of employed graphics processing units and also determinations regarding how to distribute various portions of the scene generated at operation 1612 among the employed graphics processing units. Some example techniques for making graphics processing unit scaling determinations are described above, for example, with respect to FIGS. 7-10 and throughout the present disclosure.

At operation 1618, one or more graphics processing units are employed to generate renderings in association with the scene. The renderings may be generated in accordance with the graphics processing unit scaling determinations made at operation 1616. As set forth above, if multiple graphics processing units are employed at operation 1618, the multiple graphics processing units may, in some cases, generate renderings associated with the scene at least partially simultaneously with one another. Also, in some cases, the use of multiple graphics processing units may reduce the overall time required for rendering of a scene as compared to when only a single graphics processing unit is employed to render the scene.

At operation 1620, the renderings generated at operation 1618 are associated with one or more views of the scene. In some example scenarios, a single graphics processing unit may be employed to generate a single view of the scene. Also, in some example scenarios, multiple graphics processing units may each generate a respective view of the scene. Also, in some example scenarios, multiple graphics processing units may combine to form a single view of the scene. Also, in some example scenarios, multiple graphics processing units may combine to form multiple views of the scene. Moreover, any combination of the above or other example scenarios may also be employed. Accordingly, operation 1620 may include, for example, determining and/or identifying which portions of the generated renderings will be incorporated into each rendered view that is generated based on the scene. A rendering or portion of a rendering may, for example, be associated with each view that includes the rendering or portion of the rendering. Operation 1620 may also include, for example, combining portions of renderings from multiple graphics processing units into one or more views. Some example techniques for combining renderings from multiple graphics processing units into a view, such as stitching and layering techniques, are illustrated in FIGS. 11-13 and described in detail above. In some cases, when multiple graphics processing units are combined to form multiple views of the scene, combining techniques, such as stitching and layering, may be wholly or partially repeated for each of the multiple views.

At operation 1622, the one or more views of the scene are transmitted by the content provider to one or more participating clients. As set forth above, in some cases, a different respective streaming server may be employed for transmissions to a respective client. As also set forth above, in some cases, multiple different views may be formed in association with a scene. In some of these cases, each of the multiple different views may include a different respective image associated with the scene. Thus, in some cases, multiple different images may be formed at operation 1620 and transmitted at operation 1622.

At operation 1624, it is determined if there are any remaining scenes for generation in association with the content item being transmitted. If so, then the process returns to operation 1612. By contrast, if no scenes remain for generation, then transmission of the content item is terminated at operation 1626.

As set forth above, in some cases, renderings from different graphics processing units may be combined together to form one or more views of a scene. Some of the examples described above may indicate that the renderings from different graphics processing units may be combined together by the content provider. However, in some cases, the renderings from different graphics processing units may be combined together by a client in accordance with the disclosed techniques. In such cases, a content provider may, for example, transmit renderings from multiple graphics processing units to a client without first combining the multiple renderings into one or views. The client may then receive the renderings and combine the renderings into one or more views at the client. The client may employ any combination of the stitching and layering techniques described above or any other appropriate techniques to combine the received renderings.

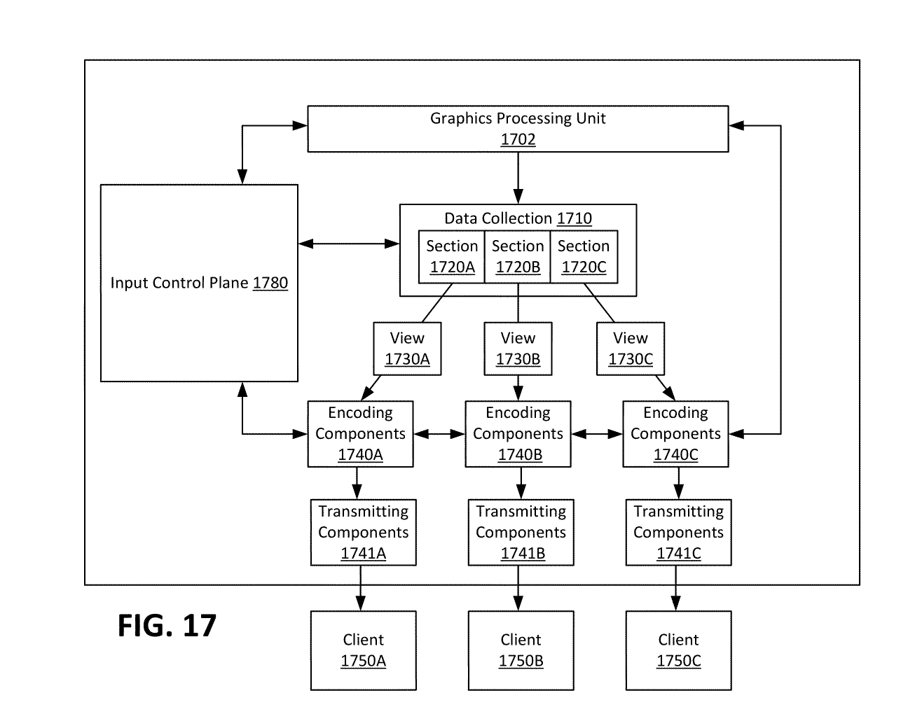

In some cases, data associated with multiple different views of a scene may be combined into a single data collection, such as a render target. An example system for employing a data collection for multiple view generation in accordance with the present disclosure is illustrated in FIG. 17. As shown, content provider 1700 includes graphics processing unit 1702, which, as described above, may be used to generate data associated with multiple views 1730A-C of a content item scene. In the example of FIG. 17, three views 1730A-C are transmitted to three clients 1750A-C. In particular, view 1730A is transmitted to client 1750A, view 1730B is transmitted to client 1750B and view 1730C is transmitted to client 1750C.

As shown in FIG. 17, graphics processing unit 1702 and/or other components generate a data collection 1710 that includes and/or stores data associated with multiple different views. Data collection 1710 may be, for example, a render target or another collection of data. The term render target, as used herein, refers to a collection of data associated with one or more renderings or other representations of information associated with a scene. Data collection 1710 may be generated by, for example, including within the data collection 1710 data associated with one or more renderings or other representations of information associated with a scene. As will be described in detail below, the data included within the data collection 1710 may include, for example, data corresponding to manipulated geometry, vertices, pixels, colors, textures, shading and any other data associated with views of a scene. As also shown in FIG. 17, the data collection 1710 includes multiple sections 1720A-C each associated with a respective view 1730A-C. In particular, section 1720A is associated with view 1730A, section 1720B is associated with view 1730B and section 1720C is associated with view 1730C. Once again, while FIG. 17 depicts three sections 1720A-C associated with three views 1730A-C, a data collection in accordance with the disclosed techniques may include any number of different sections associated with any number of different views.

When data associated with views 1730A-C has been successfully included within sections 1720A-C, encoding components 1740A-C may each extract data from a respective section 1720A-C of data collection 1710 associated with a respective view 1730A-C. In particular, encoding components 1740A may extract data from section 1720A, encoding components 1740B may extract data from section 1720B and encoding components 1740C may extract data from section 1720C. Transmission components 1741A-C may then each respectively transmit views 1730A-C to clients 1750A-C. In some cases, each of clients 1750A-C may have a respective dedicated streaming server that enables transmission of a respective view 1730A-C to each client 1750A-C. Each dedicated respective streaming server may, in some cases, include respective encoding components and transmission components. For example, a dedicated respective streaming server for client 1750A may, in some cases, include encoding components 1740A and transmission components 1741A.

Input control plane 1780 and/or another component may, for example, be employed to determine a number of views being generated in connection with a given scene. As set forth in detail above, shared state information from clients 1750A-C may, in some cases, be employed to in part determine information associated with multiple views. Input control plane 1780 and/or another component may also, for example, assist with provisioning data collection 1710 to include sections 1720A-C, which are each associated with a respective one of the multiple views 1730A-C. Each of sections 1720A-C may, for example, be defined by parameters such as various dimensions, data addresses, data ranges, data quantities, sizes and other parameters that would allow one potion of data to be distinguishable from another. In some cases, input control plane 1780 may determine and inform graphics processing unit 1702 and/or encoding components 1740A-C of the parameters associated with the data collection 1710 and sections 1720A-C. The parameters may also be determined, in some cases, by the graphics processing unit 1702 or by another component.

Various techniques may be employed to determine the parameters of data collection 1710 and sections 1720A-C. In one example, each section 1720A-C may be equally sized and may have a length L and a width W. This may result in data collection 1710 having a size of W*3L to account for the length of each of the three sections 1720A-C. In some cases, the data collection may include additional information that may result in the data collection exceeding a size of W*3L. In some cases, each of sections 1720A-C may have different sizes with respect to one another. The use of sections with different sizes may be advantageous, for example, when views 1730A-C are associated with different resolutions. For example, different clients and/or different applications on a client may present video at different resolutions with respect to one another. In some cases, higher resolution views may have associated data collections sections with larger sizes, while lower resolution views may have associated data collections sections with smaller sizes. The use of a larger data collection section size for a higher resolution view may, for example, enable an increased quantity of data to be included in the larger section, which may assist in producing a higher resolution for the view. In some cases, input control plane 1780 or another component may determine a resolution associated with each of the views based on information provided by each client 1750A-C. Input control plane 1780 or another component may then provision data collection 1710 and sections 1720A-C based on the resolution information provided by clients 1750A-C.

The term data collection generation component is used herein to refer to any component that is employed at least in part to assist in the generation of data collection 1710. Example data collection generation components may include, for example, input control plane 1780, graphics processing unit 1702 and any other components that assist in the generation of data collection 1710. One or more of the data collection generation components may, for example, determine a number of views of a scene to be generated. When the data collection 1710 is a render target, a data collection generation component may also be referred to as a render target generation component.

As set forth above, multiple different views of a scene may, for example, each depict the scene from a different respective perspective associated with each view. Each view may, for example, be generated from the perspective of one or more respective content item entities. The respective entities may, for example, be controlled by or otherwise associated with the one or more clients to whom the rendered view is transmitted. The respective entities may include, for example, characters, vehicles or any other entity associated with a content item scene. For example, in some cases, a perspective associated with a view may depict a scene as would be viewed through the eyes of a respective character or from another position associated with a respective entity. As another example, a perspective associated with a view may depict a scene such that a respective character or other entity is in the center of the view or is otherwise positioned at a location of high interest and/or high visibility within the view.

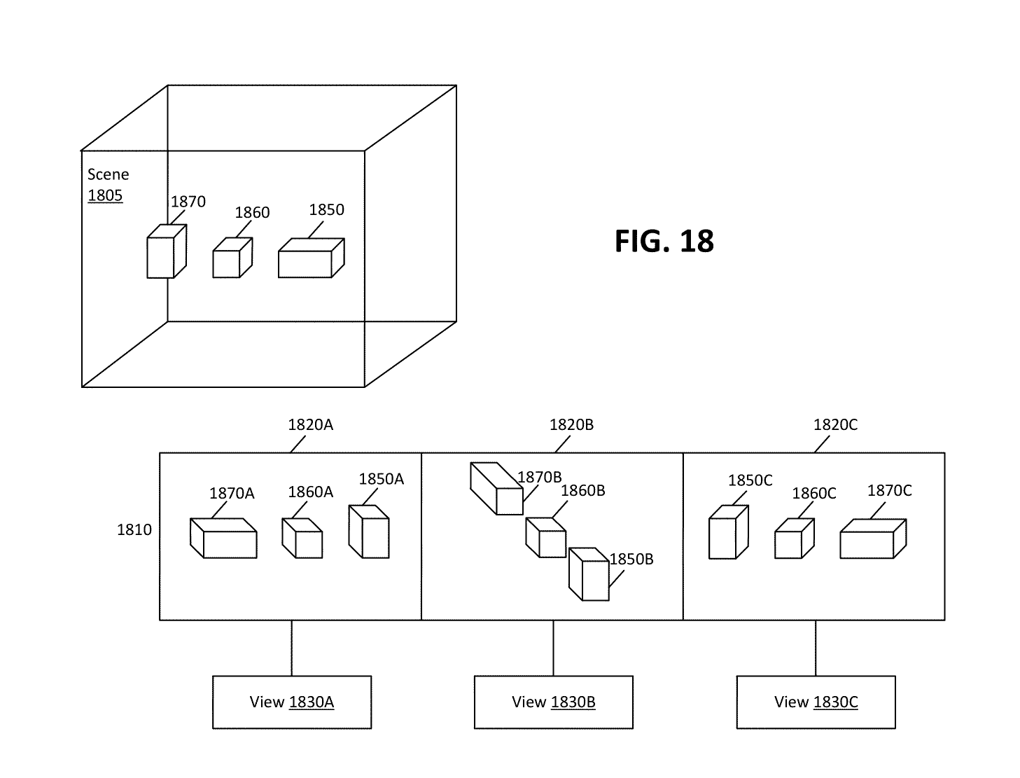

A first example data collection including data associated with multiple views in accordance with the present disclosure is illustrated in FIG. 18. As shown, data collection 1810 includes sections 1820A-C. Sections 1820A-C depict representations 1850A-C, 1860A-C and 1870A-C from three different perspectives associated with three different views 1830A-C of a scene 1805. In particular, section 1820A includes representations 1850A, 1860A and 1870A; section 1820B includes representations 1850B, 1860B and 1870B; and section 1820C includes representations 1850C, 1860C and 1870C.

Representations 1850A-C, 1860A-C and 1870A-C are representations of objects 1850, 1860 and 1870 included within scene 1805. In particular, representations 1850A-C are representations of object 1850, representations 1860A-C are representations of object 1860 and representations 1870A-C are representations of object 1870. It is noted that objects 1850, 1860 and 1870 and representations 1850A-C, 1860A-C and 1870A-C may include any number of different textures and colors and other visual effects. However, for purposes of simplicity, these visual effects are not shown in FIG. 18-20.

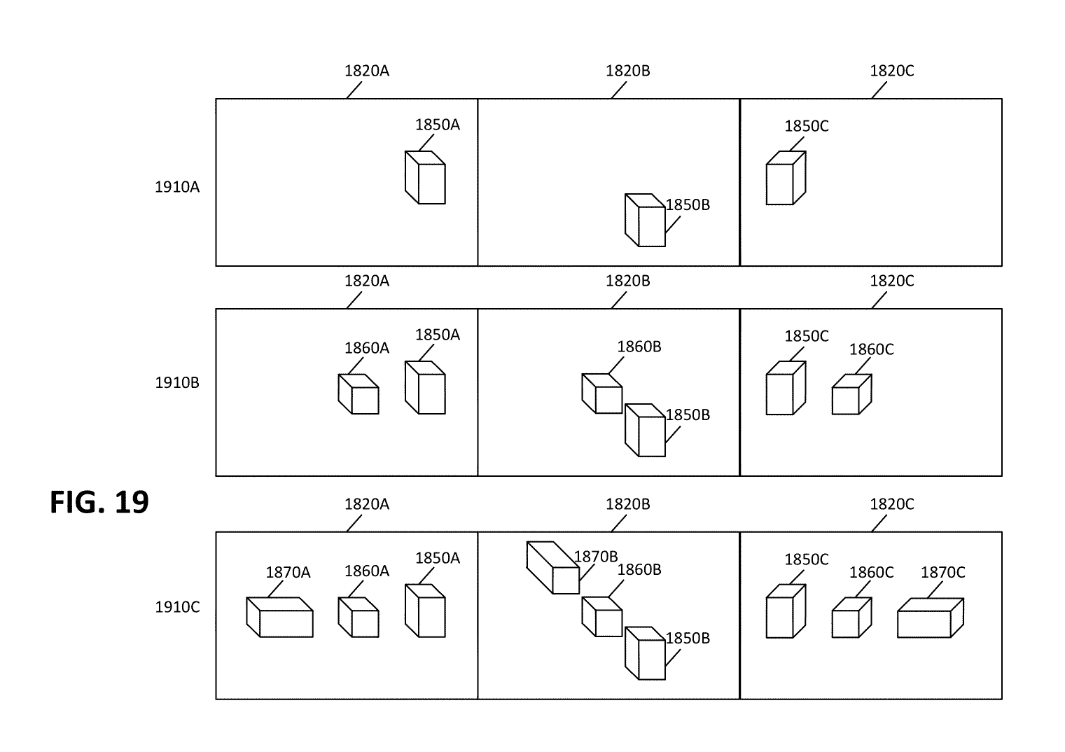

In some cases, a graphics processing unit may form representations of an object in each section of a data collection before moving on to form representations of another object. An example of this representation formation sequence is illustrated in FIG. 19. In particular, FIG. 19 shows data collection 1810 of FIG. 18 at three different stages of formation. Stage 1910A is a first stage of formation, which occurs prior to second stage 1910B and third stage 1910C. As shown, at first stage 1910A, only representations 1850A-C associated with object 1850 have been formed in sections 1820A-C.

In some cases, the formation of representations 1850A-C may include the performance of operations, such as various geometry manipulations, coloring, texturing and shading. For example, in some cases, representation 1850A may first be formed in section 1820A. The formation of representation 1850A may include, for example, loading geometry associated with object 1850 in scene 1805 and manipulating the geometry of object 1850 such that it is presented from a perspective associated with view 1830A. The formation of representation 1850A may also include, for example, applying various colors, textures and/or shaders to representation 1850A. The application of textures to representation 1850A may include, for example, loading one or more stored texture files associated with object 1850. The application of shaders to representation 1850A may include, for example, loading one or more shader programs associated with object 1850.

In some cases, after the formation of representation 1850A in section 1820A, representation 1850B may be formed in section 1820B. However, because representation 1850B is formed after representation 1850A, the geometry, textures, shaders and various other programs and information associated with object 1850 may, in some cases, already be loaded by the graphics processing unit. Thus, the formation of representation 1850B may, in some cases, require significantly less loading and other retrieval operations than were required to form representation 1850A. The formation of representation 1850B may include, for example, manipulation of the already loaded geometry of object 1850 such that it is presented from a perspective associated with view 1830B. The formation of representation 1850B may also include, for example, applying various colors, and textures and/or shaders to representation 1850A. As set forth above, the textures and shaders applied to representation 1850B may include, for example, previously loaded textures and shaders that were previously used for the formation of representation 1850A.

In some cases, after the formation of representation 1850B in section 1820B, representation 1850C may be formed in section 1820C. However, once again, because representation 1850C is formed after representations 1850A and 1850B, the geometry, textures, shaders and various other programs and information associated with object 1850 may, in some cases, already be loaded by the graphics processing unit. Thus, similar to representation 1850B, the formation of representation 1850C may also, in some cases, require significantly less loading and other retrieval operations than were required to form representation 1850A. The formation of representation 1850C may include, for example, manipulation of the already loaded geometry of object 1850 such that it is presented from a perspective associated with view 1830C. The formation of representation 1850C may also include, for example, applying various colors, and textures and/or shaders to representation 1850C. As set forth above, the textures and shaders applied to representation 1850C may include, for example, previously loaded textures and shaders that were previously used for the formation of representations 1850A and 1850B.

Stage 1910B of FIG. 19 is a second stage of formation, which occurs subsequent to first stage 1910A and prior to third stage 1910C. As shown, at second stage 1910B, representations 1850A-C associated with object 1850 and representation 1860A-C associated with object 1860 have been formed in sections 1820A-C. In some cases, representations 1860A-C may be formed by first forming representation 1860A followed by 1860B followed by 1860C. The formation of representation 1860A may include, for example, loading of the geometry associated with object 1860, loading of one or more textures associated with object 1860 and loading of one or more shaders associated with object 1860. However, when representation 1860B and 1860C are formed after representation 1860A, the geometry, textures, shaders and various other programs and information associated with object 1860 may, in some cases, already be loaded by the graphics processing unit. Thus, the formation of representations 1860B and 1860C may, in some cases, require significantly less loading and other retrieval operations than were required to form representation 1860A.

Stage 1910C is a third stage of formation, which occurs subsequent to first stage 1910A and second stage 1910C. As shown, at third stage 1910C, representations 1850A-C, 1860A-C and 1870A-C have been formed in sections 1820A-C. In some cases, representations 1870A-C may be formed by first forming representation 1870A followed by 1870B followed by 1870C. The formation of representation 1870A may include, for example, loading of the geometry associated with object 1870, loading of one or more textures associated with object 1870 and loading of one or more shaders associated with object 1870. However, when representation 1870B and 1870C are formed after representation 1870A, the geometry, textures, shaders and various other programs and information associated with object 1870 may, in some cases, already be loaded by the graphics processing unit. Thus, the formation of representations 1870B and 1870C may, in some cases, require significantly less loading and other retrieval operations than were required to form representation 1870A.

As should be appreciated, in addition to manipulation of geometry and application of colors, textures and shaders, other graphics operations may be performed in accordance with the formation of any or all of representations in sections 1820A-C. Such other graphics operations may include, for example, various other transformation operations, lighting, clipping, scan conversion, rasterization, blurring and the like.

Thus, FIG. 19 depicts an example in which a graphics processing unit forms representations of an object in each section of a data collection before moving on to form representations of another object. As set forth above, this formation sequence may, in some cases, be advantageous by, for example, reducing or eliminating a need to repeatedly retrieve or load geometry, textures, shaders and other programs or information associated with each object. In some cases, at least some of the geometry, textures, shaders and other programs or information may be loaded only once for the first representation formed in association with each object. Subsequent representations of the same object may then be formed without re-loading the already loaded geometry, textures, shaders and other programs or information. In some cases, each instance of loading of geometry, textures or shaders may cause the graphics processing unit to undergo a processing state change. Such state changes may increase the latency associated with generation of multiple views of a scene.

In some cases, use of the formation sequence such as illustrated in FIG. 19 may significantly reduce the amount of state changes required to generate multiple views of a scene. For example, in some cases, the number of state changes may be reduced by a factor corresponding to an amount of objects in the scene. For example, consider an alternative formation sequence in which data collection 1810 of FIG. 18 is formed by first forming each representation in section 1820A (including representations 1850A, 1860A and 1870A) and then forming each representation in section 1820B (including representations 1850B, 1860B and 1870A) and then forming each representation in section 1820C (including representations 1850C, 1860C and 1870C). This alternative formation sequence may, in some cases, require three times as many state changes than would be required to employ the formation sequence depicted in FIG. 19. This is because the alternative formation sequence may require geometry, textures, shaders and other programs or information to be loaded every time for every representation—as opposed to performing loading for only a first representation associated with each object without re-loading for subsequent representations associated with each object.

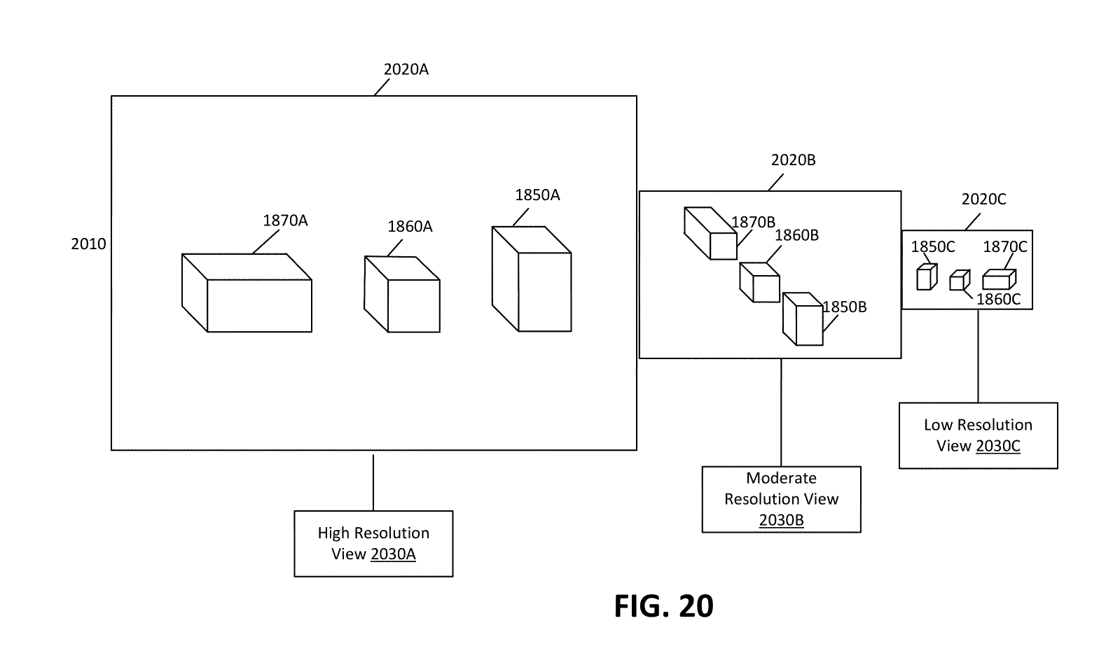

Referring back to FIG. 18, it is noted that data collection 1810 of FIG. 18 includes equal size sections 1820A-C. As set forth above, however, there is no requirement that sections within a data collection must necessarily be of equal sizes. In some cases, a data collection may include sections having different respective sizes. Each of the different respective sizes may include or may be capable of including different quantities of data with respect to one another. In particular, larger sized sections may, in some cases, include or may be capable of including a larger quantity of data in comparison to smaller sized sections. The size of each section and/or the quantity of data included in each section may, in some cases, be determined based on a resolution corresponding to one or more clients that receive a view with which the section is associated. For example, different clients and/or different applications on a client may present video at different resolutions with respect to one another. In some cases, larger sized sections including larger quantities of data may correspond to views associated with higher resolutions, while smaller sized sections including smaller quantities of data may correspond to views associated with lower resolutions. FIG. 20 depicts a data collection 2010 that includes sections 2020A-C each having different sizes with respect to one another. As set forth above, the use of sections 2020A-C with different sizes may be advantageous, for example, when views are associated with different resolutions. In particular, as shown in FIG. 20, section 2020A is associated with high resolution view 2030A, section 2020B is associated with moderate resolution view 2030B and section 2020C is associated with low resolution view 2030C. Section 2020A may include a larger quantity of data than section 2020B, which, in turn, may include a larger quantity of data than section 2020C.

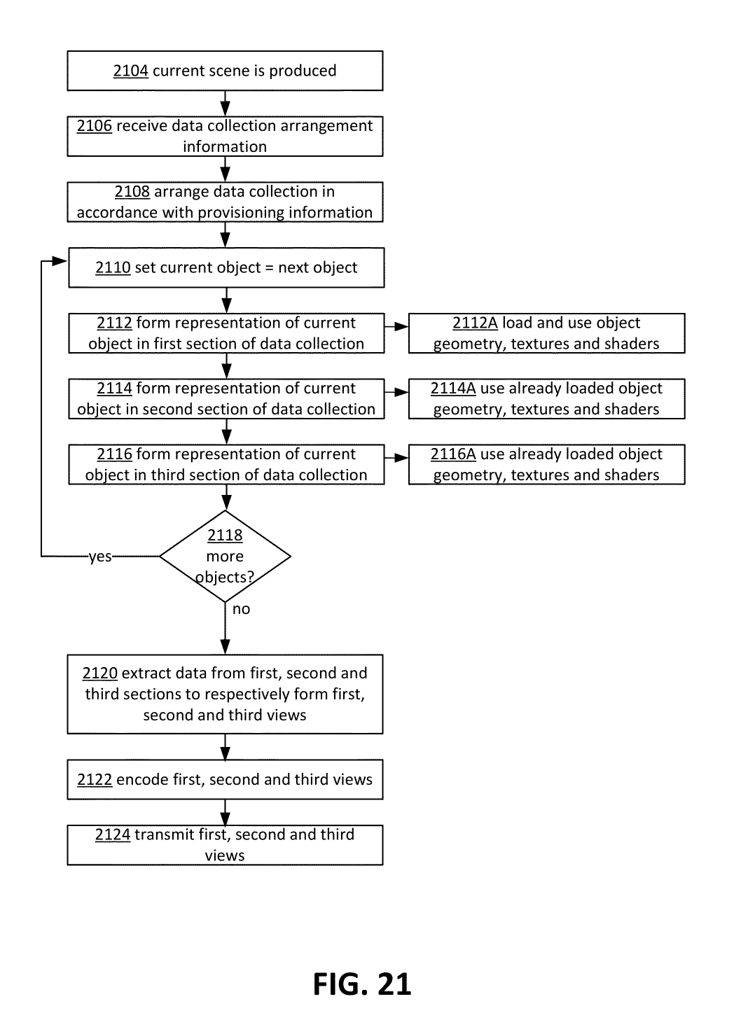

FIG. 21 is a flowchart depicting an example procedure for employing a data collection for multiple view generation in accordance with the present disclosure. The flowchart of FIG. 21 is directed to a particular example in which a data collection includes three sections that are respectively associated with three views of a current scene. It is once again noted, however, that the disclosed techniques may be employed in association with a data collection that includes any number of different sections that are respectively associated with any number of different views.

At operation 2104, a current scene is produced. As set forth above, a scene may be produced at least in part by a content item, such as a video game and/or other components. The current scene may be produced based upon, for example, information in the content item and state information provided by one or more clients.

At operation 2106, data collection arrangement information is received. The data collection arrangement information may include, for example, a number of views being generated for each scene and/or the current scene of the content item, a resolution associated with each view and any other information that may be used to provision the data collection. The content provider may employ a number of different techniques to determine the number of views being generated.

For example, in some cases, each different client to which a content item is transmitted may receive its own respective view. Also, in some cases, each client that controls or is otherwise associated with a different character or other entity may receive its own respective view. However, as set forth above, certain clients that control different entities may, in some cases, receive an identical view. Also, in some cases, clients that control the same character or another entity may receive an identical view. In some cases, each client that employs or is otherwise associated with a different display resolution may receive its own respective view. In some cases, a number of views may be determined based on state information or other information provided by one or more clients.

At operation 2108, a data collection is arranged based on the arrangement information identified at operation 2106. The arrangement of the data collection may include, for example, determining a number of sections to be included in the data collection. The arrangement of the data collection may also include, for example, defining parameters, such as various dimensions, data addresses, data ranges, data quantities, sizes and other parameters associated with each section. In some cases, the size of each section may be determined based on a resolution associated with one or more clients that receive a view corresponding to each section. As set forth above, in some cases, an input control plane and/or another component may determine and inform a graphics processing unit and/or various encoding and transmission components of the dimensions or other parameters associated with the data collection and its sections. The dimensions or other parameters may also be determined, in some cases, by a graphics processing unit or by another component.

In some cases, operations 2106 and 2108 need not necessarily be repeated for each different scene that is produced in association with a playing of a content item. For example, in some cases, operations 2106 and 2108 may be performed at the initiation of a playing of a content item, and the arrangement of each data collection for each scene may remain constant for as long as the arrangement information remains substantially consistent from one scene to the next. In some cases, certain changes may occur that may cause the data collection to be re-arranged for the next scene that is produced after the changes are detected. For example, when it is detected that one or more clients have joined or terminated their participation in a playing of a video game, then a data collection for a subsequent scene may be re-arranged based on the detection of this information. In particular, for example, the data collection for the subsequent scene may be re-arranged to include additional of fewer sections as necessary based on the information.

At operation 2110, a current object is iterated such that a current object is set to be a next object. The current object is the object whose representations are formed in the data collection at operations 2112-2116. For example, referring back to the example depicted in FIG. 19, a first iteration of operation 2110 may include setting object 1850 to be a current object. As another example, a second iteration of operation 2110 may include setting object 1860 to be a current object. It is noted that operation 2110 is included for purposes of simplicity to clarify to the reader that operations in the process of FIG. 21 may be repeated for one or more objects in the current scene. Operation 2110 need not necessarily require any processing or computation by the content provider. Any number of techniques may be employed to determine an order in which objects in a scene are selected as a current object. For example, the order may be determined by a content item, by a graphics processing unit or by another component. The order may be determined based on factors such as a relative depth of the objects with respect to perspectives associated with one or more views or any other appropriate factors.

At operation 2112, a representation of the current object is formed in the first section of the data collection. For example, referring back to the example depicted in FIG. 19, the first iteration of operation 2112 may include forming of representation 1850A in section 1820A. Sub-operation 2112A indicates that operation 2112 may include, for example, loading and using geometry, textures and shaders associated with the current object. For example, the geometry of the current object may be loaded and manipulated to form a representation presented from a perspective corresponding to a view associated with the first section. Additionally, various textures and shaders associated with the current object may be loaded and applied to the representation being formed in the first section. Any number of other additional or alternative operations may also be performed in order to form the representation in the first section.

At operation 2114, a representation of the current object is formed in the second section of the data collection. For example, referring back to the example depicted in FIG. 19, the first iteration of operation 2114 may include forming of representation 1850B in section 1820B. Sub-operation 2114A indicates that operation 2114 may include, for example, using already loaded geometry, textures and shaders associated with the current object. For example, in some cases, the geometry of the current object that was loaded at sub-operation 2112A may be manipulated to form a representation presented from a perspective corresponding to a view associated with the second section. Additionally, in some cases, various textures and shaders associated with the current object that were loaded at sub-operation 2112A may be applied to the representation being formed in the second section. Any number of other additional or alternative operations may also be performed in order to form the representation in the second section.

At operation 2116, a representation of the current object is formed in the third section of the data collection. For example, referring back to the example depicted in FIG. 19, the first iteration of operation 2116 may include forming of representation 1850C in section 1820C. Sub-operation 2116A indicates that operation 2116 may include, for example, using already loaded geometry, textures and shaders associated with the current object. For example, in some cases, the geometry of the current object that was loaded at sub-operation 2112A may be manipulated to form a representation presented from a perspective corresponding to a view associated with the third section. Additionally, in some cases, various textures and shaders associated with the current object that were loaded at sub-operation 2112A may be applied to the representation being formed in the third section. Any number of other additional or alternative appropriate geometric operations may also be performed in order to form the representation in the third section.

It is once again noted that sub-operations 2112A, 2114A and 2116A are merely intended to identify some example sub-operations that may be performed respectively at operations 2112, 2114 and 2116 and that all such sub-operations are not required and do not necessarily include a complete list of all sub-operations that may be performed in all cases. For example, in some cases, operations 2114 and 2116 may include the use of some geometry, textures, shaders and/or other components that were not previously loaded at operation 2112 or another operation.

At operation 2118, it is determined whether there are any objects remaining in the current scene whose representations have not yet been formed in the data collection. If so, then the process returns to operation 2110, at which the current object is set to be a next remaining object. Operations 2112-2116 are then repeated to form representations of the next object in each section of the data collection. For example, referring back to the example depicted in FIG. 19, the second iteration of operations 2112-2116 may include forming of representations 1860A-C, and the third iteration of operations 2112-2116 may include the forming of representations 1870A-C. In some cases, the data collection may be generated by, for example, performing operations 2112-2116 for each object in the scene to the extent appropriate for each view. In some cases, however, the data collection may be generated without necessarily forming object representations in the order depicted in FIG. 21. In some cases, certain objects within a scene need not necessarily be included within a particular view or have a corresponding representation formed within a section of the data collection associated with the particular view. This may occur, for example, when an object is positioned outside of a viewing area associated with the particular view.

If, at operation 2118, it is determined that there are no objects remaining in the scene whose representations have not yet been formed in the data collection, then the process proceeds to operation 2120, at which at least a portion of data is extracted from each of the first, second and third sections of the data collection to respectively form a first, second and third view of the current scene. At operation 2122, the first, second and third views are encoded, and, at operation 2124, the first, second and third views are transmitted. In some cases, each of the first, second and third views may be transmitted to different respective first, second and third clients. In other cases, one or more of the views may be transmitted to a single client. As set forth above, in some cases, each of the first, second and third views may be encoded and transmitted by dedicated respective encoding and transmission components that may, for example, include or be included within dedicated respective streaming servers.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments. The components described herein may be, for example, structural components including one or more algorithms for execution in association with one or processors.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network or a portable media article to be read by an appropriate drive or via an appropriate connection. The systems, modules and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein.

The accompanying claims and their equivalents are intended to cover such forms or modifications as would fall within the scope and spirit of certain of the inventions disclosed herein.

What is claimed is:

1. One or more compute nodes comprising:
a processor;
memory having stored therein instructions executed by the processor;
one or more render target generation components configured to:
determine to generate at least a first view and a second view of a scene of a content item, wherein the first view presents the scene from a first perspective associated with a first client and wherein the second view presents the scene from a second perspective associated with a second client, wherein the scene comprises at least a first object and a second object; and
generate a render target that comprises a first section associated with the first view and a second section associated with the second view by at least:
forming, in the first section of the render target, a first representation of the first object from the first perspective and forming, in the second section of the render target, a second representation of the first object from the second perspective; and
subsequent to forming the first and the second representations of the first object, forming, in the first section of the render target, a first representation of a second object from the first perspective and forming, in the second section of the render target, a second representation of the second object from the second perspective;
a first encoding component configured to encode data from at least part of the first section of the render target to form an encoded first view;
a second encoding component configured to encode data from at least part of the second section of the render target to form an encoded second view;
a first transmission component configured to transmit the encoded first view to the first client; and
a second transmission component configured to transmit the encoded second view to the second client.

2. The one or more compute nodes of claim 1, wherein a quantity of data stored in the first section is different than a quantity of data stored in the second section, wherein the quantity of data stored in the first section is based at least in part on a resolution associated with the first client, and wherein the quantity of data stored in the second section is based at least in part on a resolution associated with the second client.

3. The one or more compute nodes of claim 1, wherein forming the first representation of the first object comprises performing a manipulation on a geometry associated with the first object, applying one or more textures to the first representation of the first object and applying one or more shaders to the first representation of the first object.

4. The one or more compute nodes of claim 1, wherein forming the first representation of the first object comprises loading a shader and applying the shader to the first representation of the first object, and wherein forming the second representation of the first object comprises applying the shader to the second representation of the second object without re-loading the shader.

5. A computer-implemented method of generating, by one or more compute nodes, at least a first view and a second view of a scene of a content item comprising:
determining to generate at least the first view and the second view of the scene of the content item, wherein the first view presents the scene from a first perspective associated with a first client and wherein the second view presents the scene from a second perspective associated with a second client, wherein the scene comprises one or more objects;
generating a data collection that comprises a first section associated with the first view and a second section associated with the second view, wherein the first section comprises a representation of at least one of the one or more objects formed from the first perspective, and wherein the second section comprises a representation of at least one of the one or more objects formed from the second perspective;
extracting data from at least part of the first section of the data collection to form the first view;
extracting data from at least part of the second section of the data collection to form the second view;
transmitting the first view to the first client; and
transmitting the second view to the second client.

6. The computer-implemented method of claim 5, wherein the first perspective is associated with an entity within the content item that is controlled by the first client, and wherein the second perspective is associated with an entity within the content item that is controlled by the second client.

7. The computer-implemented method of claim 5, wherein a quantity of data stored in the first section is different than a quantity of data stored in the second section, wherein the quantity of data stored in the first section is based at least in part on a resolution associated with the first client, and wherein the quantity of data stored in the second section is based at least in part on a resolution associated with the second client.

8. The computer-implemented method of claim 5, wherein the one or more objects included in the scene comprise at least a first object and a second object, and wherein the generating the data collection comprises:
forming, in the first section of the data collection, a first representation of the first object from the first perspective and forming, in the second section of the data collection, a second representation of the first object from the second perspective; and
subsequent to forming the first and the second representations of the first object, forming, in the first section of the data collection, a first representation of a second object from the first perspective and forming, in the second section of the data collection, a second representation of the second object from the second perspective.

9. The computer-implemented method of claim 8, wherein forming the first representation of the first object comprises performing a manipulation on a geometry associated with the first object, applying one or more textures to the first representation of the first object and applying one or more shaders to the first representation of the first object.

10. The computer-implemented method of claim 8, wherein forming the first representation of the first object comprises loading a shader and applying the shader to first representation of the first object, and wherein forming the second representation of the first object comprises applying the shader to the second representation of the second object without re-loading the shader.

11. The computer-implemented method of claim 8, wherein forming the first representation of the first object comprises loading a texture and applying the texture to first representation of the first object, and wherein forming the second representation of the first object comprises applying the texture to the second representation of the second object without re-loading the texture.

12. The computer-implemented method of claim 5, further comprising:
determining a number of views of the scene being generated; and
arranging the data collection to include a number of sections determined based on the number of views of the scene being generated.

13. The computer-implemented method of claim 5, wherein the data collection further comprises a third section associated with a third view of the scene from a third perspective associated with a third client.

14. The computer-implemented method of claim 5, wherein the one or more compute nodes comprise a first streaming server that transmits the first view to the first client and a second streaming server that transmits the second view to the second client.

15. One or more non-transitory computer-readable storage media having stored thereon instructions that, upon execution on at least one compute node, cause the at least one compute node to perform operations comprising:
determining to generate at least a first view and a second view of a scene of a content item, wherein the first view presents the scene from a first perspective associated with a first client and wherein the second view presents the scene from a second perspective associated with a second client, wherein the scene comprises one or more objects;
generating a data collection that comprises a first section associated with the first view and a second section associated with the second view, wherein the first section comprises a representation of at least one of the one or more objects formed from the first perspective, and wherein the second section comprises a representation of at least one of the one or more objects formed from the second perspective;
encoding data from at least part of the first section of the data collection to form an encoded first view;
encoding data from at least part of the second section of the data collection to form an encoded second view;
transmitting the encoded first view to the first client; and
transmitting the encoded second view to the second client.

16. The non-transitory computer-readable storage media of claim 15, wherein the first perspective is associated with an entity within the content item that is controlled by the first client, and wherein the second perspective is associated with an entity within the content item that is controlled by the second client.

17. The non-transitory computer-readable storage media of claim 15, wherein a quantity of data stored in the first section is different than a quantity of data stored in the second section, wherein the quantity of data stored in the first section is based at least in part on a resolution associated with the first client, and wherein the quantity of data stored in the second section is based at least in part on a resolution associated with the second client.

18. The non-transitory computer-readable storage media of claim 15, wherein the one or more objects included in the scene comprise at least a first object and a second object, and wherein the generating the data collection comprises:
forming, in the first section of the data collection, a first representation of the first object from the first perspective and forming, in the second section of the data collection, a second representation of the first object from the second perspective; and
subsequent to forming the first and the second representation of the first object, forming, in the first section of the data collection, a first representation of a second object from the first perspective and forming, in the second section of the data collection, a second representation of the second object from the second perspective.

19. The non-transitory computer-readable storage media of claim 18, wherein forming the first representation of the first object comprises performing a manipulation on a geometry associated with the first object, applying one or more textures to the first representation of the first object and applying one or more shaders to the first representation of the first object.

20. The non-transitory computer-readable storage media of claim 18, wherein forming the first representation of the first object comprises loading a shader and applying the shader to first representation of the first object, and wherein forming the second representation of the first object comprises applying the shader to the second representation of the second object without re-loading the shader.

21. The non-transitory computer-readable storage media of claim 18, wherein forming the first representation of the first object comprises loading a texture and applying the texture to first representation of the first object, and wherein forming the second representation of the first object comprises applying the texture to the second representation of the second object without re-loading the texture.

22. The non-transitory computer-readable storage media of claim 15, wherein the operations further comprise:
determining a number of views of the scene being generated; and
arranging the data collection to include a number of sections determined based on the number of views of the scene being generated.

23. The non-transitory computer-readable storage media of claim 15, wherein the data collection further comprises a third section associated with a third view of the scene from a third perspective associated with a third client.

24. The non-transitory computer-readable storage media claim 15, wherein the one or more compute nodes comprise a first streaming server that transmits the first view to the first client and a second streaming server that transmits the second view to the second client.
